(19) United States
(12) Patent Application Publication
(10) Pub. No.: US 2008/0075561 A1
(43) Pub. Date: Mar. 27, 2008

(54) Robot joint mechanism and method of driving the same

(75) Inventors: Yoshinari Takemura, Saitama (JP); Yuichi Uebayashi, Saitama (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Honda Motor Co., Ltd.

(21) Appl. No.: 11/896,092

(22) Filed: Aug. 29, 2007

(30) Foreign Application Priority Data
Aug. 30, 2006 (JP) 2006-234576

(51) Int. Cl. B25J 18/06

(52) U.S. Cl. 414/2; 414/800; 901/9

(57) ABSTRACT

A robot joint mechanism includes: a drive power source and a load member driven by an output of the drive power source, and further includes: speeding-up means coupled to the drive power source and the load member such that the output of the drive power source is transmitted to the load member with the output of the drive power source speeded up, wherein the speeding-up means transmits the output of the drive power source with a part of the speeding-up means elastically deformed. The flexible member may be an annular spring. The speeding-up means includes a four-link mechanism, in which a speed of the output link is higher than that of the input link. The input link may be flexible.

### CROSS REFERENCE TO RELATED APPLICATIONS

This application claims the foreign priority benefit under Title 35, United States Code, §119(a)-(d) of Japanese Patent Application No. 2006-234576, filed on Aug. 30, 2006 in the Japan Patent Office, the disclosure of which is herein incorporated by reference in its entirety.

### BACKGROUND OF THE INVENTION

1. Field of the Invention

The present invention relates to a robot joint mechanism and a method of driving the same.

2. Description of the Related Art

A robot joint mechanism is known which includes a drive power source such as a hydraulic actuator, a load of the robot joint mechanism, and a flexible member for transmitting the drive power source therethrough to the load. U.S. Pat. No. 5,650,704 discloses such a technology.

### SUMMARY OF THE INVENTION

A first aspect of the present invention provides a robot joint mechanism including a drive power source and a load member driven by an output of the drive power source, comprising: speeding-up means coupled to the drive power source and the load member such that the output of the drive power source is transmitted to the load member with the output of the drive power source speeded up, and wherein the speeding-up means transmits the output of the drive power source with a part of the speeding-up means elastically deformed.

The speeding-up means for speeding up the drive power may be provided by any of various types of link mechanism such as a four-link mechanism, a gear mechanism, or a combination of a belt and pulley.

The output of the drive power source may be a linear output power or a rotary output power. The speeding-up means may provide a liner speed increase or a rotary speed increase.

In the robot joint mechanism, the speeding-up means for transmitting the drive power through the flexible member is provided between the drive power source and the load. This may increase a spring constant of the flexible member. In other words, this improves a power transmission property and a response. Further, this reduces a quantity of deformation of the flexible member. Thus, in the robot, a response to an instruction can be improved and a space efficiency can be improved.

If the load member collides with an obstacle, the speeding-up means is driven from the side of the load member, serving as a speed-reducing element, which decreases a speed variation due to the collision. This reduces variations of the impact transmitted to the drive power source, which suppresses occurrence of failures in the drive power source due to the impact. In other words, this improves a resistance to the collision.

A second aspect of the present invention provides the robot joint mechanism based on the first aspect, wherein the drive power source comprises: a motor; and a reducing mechanism for reducing a speed of an output of the motor and transmitting a reduced output of the motor to the speeding-up means.

A third aspect of the present invention provides the robot joint mechanism based on the first aspect, wherein the speeding-up means comprises: an elastic member coupled to the drive power source; and a speeding-up mechanism couple to the elastic member and the load member, wherein the output of the drive power source transmitted through the elastic member is transmitted to the load member with speeding up.

A fourth aspect of the present invention provides the robot joint mechanism based on the third aspect, wherein the elastic member comprises an annular spring elastically deformable in a twisting direction, and wherein the annular spring comprises a center part coupled to one of the drive power source and the load member; a peripheral member, coupled to the other of the drive power source and the load member, arranged around the center part in a radial direction of the center part; and a flexible member for connecting the center part to the peripheral part.

In the robot joint mechanism according to the fourth aspect includes the annular spring which can reduces a necessary space in an axial direction of the annular spring in comparison with the case where the torsion bar is used. Further, this structure may include one spring (the annular spring) having a strength corresponds to a maximum load torque because of no necessity of a preload pressure required in the two-torsion coil spring, and thus eliminate the necessity of two torsion coil springs. Further, the annular spring may not show hysteresis because of no contact element therein.

A fifth aspect of the present invention provides the robot joint mechanism based on the fourth aspect, wherein the flexible part is line-symmetry about at least one axis on a cross section orthogonal to a rotation axis of the annular spring.

In the robot joint mechanism according to the fifth aspect, the flexible member has first and second portions which are line-symmetrical with each other about one axis on a cross section orthogonal with the rotation axis. This makes the annular spring simple in structure. Further, this may equalize spring constants in the opposite rotary directions. In other words, this makes an elasticity characteristic symmetrical in opposite rotary directions.

A sixth aspect of the present invention provides the robot joint mechanism based on the fourth aspect, wherein the flexible part is n-rotationally symmetrical about the rotation axis of the annular spring, n being a natural number more than one.

In the robot joint mechanism according to the sixth aspect, spring constants in opposite rotary directions can be equalized. This may suppress generation of co-advancing forces between the center part and the peripheral part while a rotation force is applied to the annular spring. More specifically, in the robot joint mechanism, forces acting on the flexible member from the center part may be point-symmetrically generated, with a result that a total of forces becomes zero. Further, the center part may be supported by a lot of points, or by n parts in n radial directions, which prevents the axis of the spring from shifting. In other words, the forces acting in the co-advancing directions when a torque is inputted into the annular spring may be small in magnitude. This can reduce a load capacity of a member for supporting the annular spring, miniaturizing parts supporting the annular spring. This may improve an accuracy in coaxiality between input and output axes of the annular spring. In this structure, the smaller the symmetrical angle (one rotational position to the next symmetrical rotary position) is, i.e., the larger n is, the larger the effect in preventing the accuracy in the coaxiality from decreasing due to anisotropy becomes.

In the robot joint mechanism according to the sixth aspect, the flexible has a shape which is n-rotationally symmetrical on a cross section orthogonal with the rotation axis. This may generate no torque due to shift between axes of the center part and the peripheral part.

A seventh aspect of the present invention provides the robot joint mechanism based on the first aspect, wherein the speeding-up means comprises a four-link mechanism, and in the four-link mechanism, one link for transmitting the output of the drive power source is elastically deformable in a displacement direction of the link.

This structure may save a space and lighten the robot joint mechanism because the speed-increasing mechanism and the flexible member are integrated.

An eighth aspect of the present invention provides the robot joint mechanism based on the seventh aspect, wherein in the four link mechanism, the one link for transmitting the output of the drive power source comprises a spring member elastically deformable in the displacement direction of the one link, and wherein the flexible member of the spring member is symmetrical about a plane including two connection axes of the one link.

This structure may provide the spring having the same spring constant in opposite rotary directions because a compression force and a tensile force are generated symmetrically in the flexible member.

A ninth aspect of the present invention provides a method of driving a robot joint mechanism for driving a load member by an output of a drive power source, comprising the steps of: reducing a speed of an output of the motor; transmitting the output of the drive power source through an elastic member; and speeding up the output of the drive power source transmitted through the elastic member and transmitting the speeded-up output of the drive power source to the load member.

The robot joint mechanism and a method of driving a robot joint mechanism may improve a resistance to an impact, a response, and a space efficiency.

### BRIEF DESCRIPTION OF THE DRAWINGS

The object and features of the present invention will become more readily apparent from the following detailed description taken in conjunction with the accompanying drawings in which:

FIG. 1 is a block diagram of the robot joint mechanism according to the present invention.

FIG. 2 is a side view of a robot to which the robot joint mechanism according to the present invention is applied.

FIG. 3 is a perspective view for illustrating a drive system of the robot shown in FIG. 2.

FIG. 4 is a perspective view of a robot joint mechanism according to a first embodiment of the present invention;

FIG. 5A is a perspective cutaway view of a part shown in FIG. 4 for illustrating an annular spring;

FIG. 5B is a perspective view of the annular spring;

FIG. 6A is a plan view of the annular spring shown in FIGS. 5A and 5B;

FIG. 6B is a sectional view, taken along line X1-X1 in FIG. 6A;

FIG. 6C is a sectional view, taken along line X2-X2 in FIG. 6A;

FIG. 7A is a plan view of a modification example of the annular spring having a line-symmetrical structure about one axis;

FIG. 7B is a plan view of the annular spring shown in FIG. 7A for explaining a twisting operation of the annular spring;

FIG. 8A is a plan view of another modification example of the annular spring having a line-symmetrical structure about two axes;

FIG. 8B is a plan view of the annular spring shown in FIG. 8A for explaining a twisting operation of the annular spring;

FIG. 9A is a plan view of a further modification example of the annular spring;

FIG. 9B is a cross-sectional view of the annular spring shown in FIG. 9A;

FIG. 9C is a perspective cutaway view of the annular spring shown in FIG. 9A;

FIG. 10 is an exploded perspective view of a main part shown in FIG. 4;

FIG. 11 is an exploded perspective view of a part shown in FIG. 4 for illustrating connection relations in the robot joint mechanism;

FIG. 12 is an illustration of a lateral swing movement mechanism for the wrist in the robot joint mechanism;

FIG. 13A is a side view for illustrating a vertical swing movement in a four-link mechanism in a state in which the hand is turned to the side of the back of the hand;

FIG. 13B is a side view for illustrating the vertical swing movement mechanism in a state in which the hand extends straight;

FIG. 13C is a side view for illustrating the vertical swing movement in a state in which the hand is turned to the side of the palm;

FIG. 14A is a side view for illustrating the vertical swing movement in a state in which the hand is turned to the side of the back of the hand by 90 degrees;

FIG. 14B is a side view for illustrating the vertical swing movement in a state in which the hand is turned to the side of the palm by 90 degrees;

FIG. 15A is a plan view for illustrating the lateral swing movement in a state in which the hand is turned counterclockwise in FIG. 15A;

FIG. 15B is a plan view for illustrating the lateral swing movement mechanism in a state in which the hand extends straight;

FIG. 15C is a plan view for illustrating the lateral swing movement in a state in which the hand is turned clockwise in FIG. 15C;

FIG. 16 is an enlarged perspective view of the joint mechanism for pivoting the wrist;

FIG. 17 is an exploded perspective view of a main part shown in FIG. 16;

FIGS. 18A and 18B are illustrations of a first link for showing deformation in operation;

FIG. 19A is an illustration for showing a pivoting operation of the wrist mechanism according to a first embodiment in a status before the hand is pivoted;

FIG. 19B is an illustration for showing the pivoting operation of the wrist mechanism according to the first embodiment in a status after the hand is pivoted;

FIG. 20 is a perspective view of the joint mechanism for pivoting the wrist according to a second embodiment;

FIG. 21 is an exploded perspective view of a main part shown in FIG. 20;

FIG. 22 is a perspective cutaway view of a drive mechanism shown in FIG. 20;

FIG. 23A is an illustration for showing a pivoting operation of the joint mechanism for pivoting the wrist according to the second embodiment in a status before the hand is pivoted;

FIG. 23B is an illustration for showing the pivoting operation of the joint mechanism for pivoting the wrist according to the second embodiment in a status after the hand is pivoted;

FIG. 24 is an illustration of a modification of the speed-increasing converting mechanism; and

FIG. 25 is a cross-sectional view of a planet gear mechanism as a modification of the speed-increasing converting mechanism.

The same or corresponding elements or parts are designated with like references throughout the drawings.

### DETAILED DESCRIPTION OF THE INVENTION

Prior to describing embodiments of the present invention, the above-mentioned related art will be further explained.

In the elastic actuator disclosed in U.S. Pat. No. 5,650,704, to obtain a higher impact absorbance, an elastic member having a smaller spring constant is required. However, if the elastic member having a smaller spring constant is used in the elastic actuator disclosed in U.S. Pat. No. 5,650,704, there may be problems regardless of a linear drive or a rotary drive.

<Low Response>

To transmit a force through an elastic member having a mass, it is required to accelerate the mass distributed over the elastic member. Generally, an elastic member having a low spring constant with the same material can be provided by elongating a transmission path for transmitting the force. In the elastic member, a delay in transmission of the force occurs because it takes a long time for the elastic member to transmit the force through a long transmission path, so that a response in a control system becomes lower.

<Low Space Efficiency>

If a force having the same intensity is applied to the elastic members having low and high spring constants, the elastic member having the low spring constant is largely deformed than the elastic member having the high spring constant. This requires a space for deformation of the elastic member, so that a space efficiency is low.

Next, will be described a problem in a case where the driving mechanism adopts a rotary driving regarding a torsion bar and a torsion coil spring which are flexible in a rotary direction.

<Torsion Bar>

A torsion bar having a low spring constant in a rotary direction can be formed by elongating the torsion bar with the same material. In a case where a driving mechanism including the torsion bar is adopted in a humanoid robot, the space efficiency is low and this influences to an outline of the humanoid robot.

<Torsion Coil Spring>

The torsion coil spring is manufactured by plastically deforming a steel wire in a coil. Thus, the torsion coil spring has different spring constants depending on a direction of twisting. To equalize spring constants in opposite rotary directions, two torsion coil springs (first and second coil springs) should be connected coaxially in opposite directions to generate a preload torque. In this case, a power of the combination of the coil springs is identical with an output load torque. The preload torque is a half of a maximum load torque.

For example, a combination of two coil springs for generating a maximum load torque of 10 [Nm] can be provided as follows:

When the load torque is 0 [Nm], a torque of +5 [Nm] and a torque of −5 [Nm] are applied to the first coil spring (for a clockwise rotation) and the second coil spring (for a counterclockwise rotation), respectively. When the load torque is applied in the clockwise ration at 10 [Nm], a torque of +10 [Nm] is applied to the first coil spring, and a torque of 0 [Nm] is applied to the second coil spring.

Thus, to equalize spring constants using the coil springs for clockwise and counterclockwise rotations, two coil springs having spring constants corresponding to the maximum load torque are required. However, use of two torsion coil springs is inefficient in view of weight and design. Further, general torsion coil springs have such a structure that neighbor parts of the steel wire are in contact with each other, which may cause a hysteresis due to friction at contacts between the neighbor parts of steel wire. To solve the above-mentioned problem, the present invention is developed to improve the impact resistance, the response, and the space efficiency in a robot joint mechanism and a method of driving the same.

With reference to drawings will be described embodiments of the present invention. The same or corresponding parts are designated with the same or corresponding references, and thus, a duplicated description will be omitted.

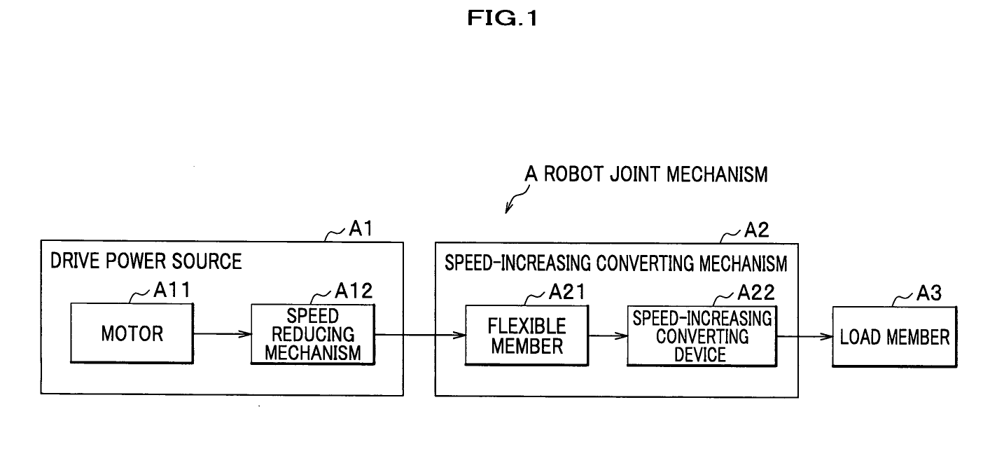

FIG. 1 is a block diagram of a robot joint mechanism A according to the present invention. As shown in FIG. 1, the robot joint mechanism A according to the present invention includes a drive power source A1, a speed-increasing converting mechanism A2, and a load member A3.

The drive power source A1 generates a drive power for driving the load member A3. The drive power (output) of the drive power source A1 is transmitted to the speed-increasing converting mechanism A2. The drive power source A1 includes a motor A11 and a speed reducing mechanism (speed-reducing converting mechanism) A12.

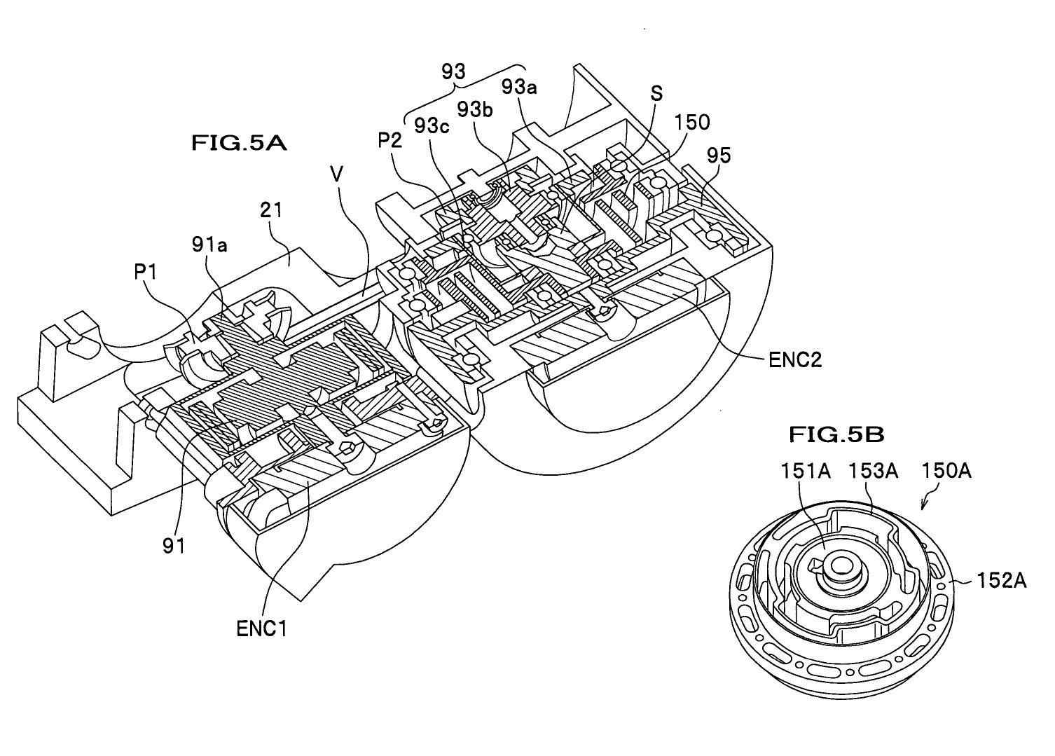

The speed reducing mechanism A12 is a mechanism for transmitting the output of the motor A11 to the speed-increasing converting mechanism A2 in which a rotation speed of the output of the motor A11 is reduced at the input of the speed-increasing mechanism A2. As the speed reducing mechanism A12 are preferably used a harmonic drive gearing 93, 112A, or 112B (See FIGS. 5, 17, and 22) mentioned later. As the drive power source, is usable a hydraulic drive power source such as a hydraulic cylinder in place of the drive power source A1 including the motor A11 and the speed reducing mechanism A12.

The speed-increasing converting mechanism A2 is installed between the drive power source A1 and the load member A3 for transmitting the output of the motor A11 to the load member A3, the rotation speed in the output of the motor A11 being decreased by the speed reducing mechanism A12. The speed-increasing converting mechanism A2 has a member for transmitting the output of the drive power source A1 through an elastic deformation.

As shown in FIG. 1, the speed-increasing converting mechanism A2 in the robot joint mechanism A shown in FIG. 1 includes, for example, an flexible member A21 and a speed-increasing mechanism A22.

The flexible member A21 is installed between the speed reducing mechanism A12 and the speed-increasing converting device A22 to transmit the output of the motor A11. The flexible member A21 is elastically deformed while the output is transmitted, and thus functions as a cushioning member between the speed reducing mechanism A12 and the speed-increasing converting device A22. As the flexible member A2 is preferably usable an annular spring 150 mentioned later (see FIG. 5B) and the like.

The speed-increasing converting device A22 is a mechanism for transmitting the output of the motor A11 transmitted through the flexible member A21 from the speed reducing mechanism A12 to the load member A3 in which the speed in the rotation speed of the motor A11 is increased. As the speed-increasing converting device A22, are preferably usable various link mechanisms, gear mechanisms, and sets of a belt and a pulley.

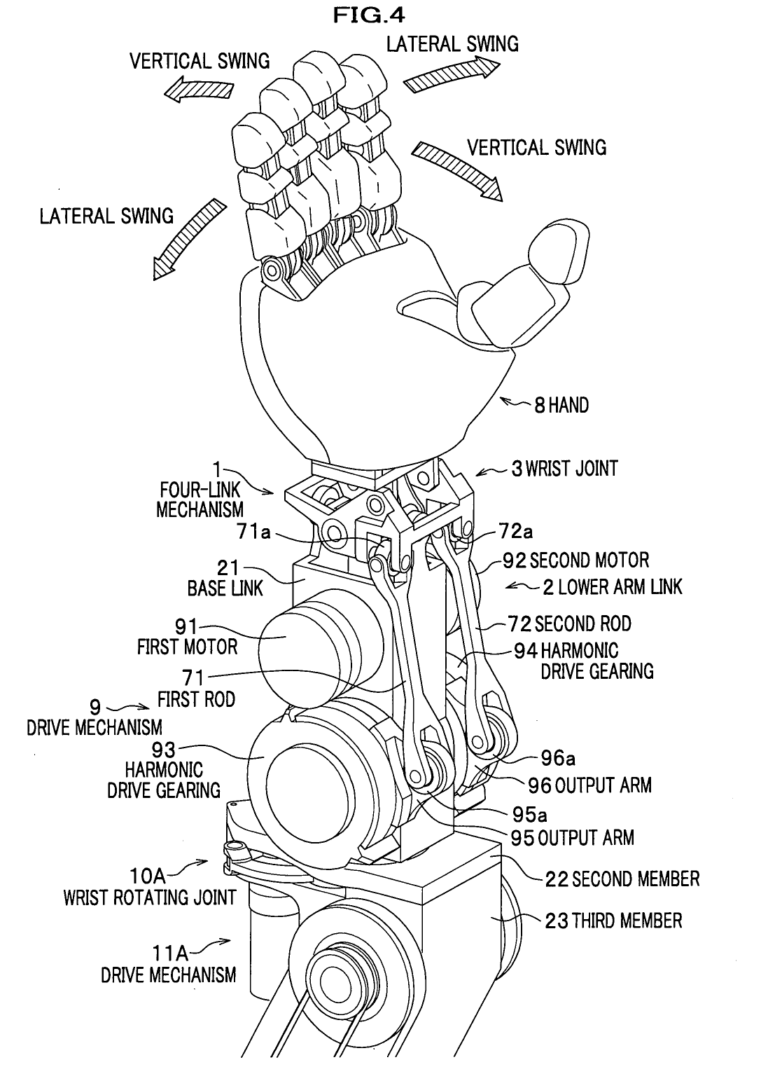

The load member A3 is a member driven by the output of the drive power source A1. As the load member A3 is exemplified a link 8 of a hand (see FIG. 4) and the like.

In a case where the speed-increasing converting device A22 includes the flexible member A21 installed on the side of the drive power source A1 and the speed-increasing converting device A22 installed on the side of the speed-increasing converting device A22, it is assumed that an inertia moment inputted into the speed-increasing converting device A22 from the load member A3 and the like is 1 [kg·m²], a spring constant of the flexible member A21 is k [N/m], a speed-increasing ratio of the speed-increasing device A22 is r (r>1), and a characteristic frequency (resonance frequency) of the flexible member A21 is f [Hz]. Then, the following relation is established.
f=(½π)·(k/Ir²)^{1/2} (1)

In a robot joint mechanism without the speed-increasing mechanism, r=1.

More specifically, because the robot joint mechanism A has the speed-increasing converting device A22, the inertia moment inputted into the flexible member A21 is Ir². This can miniaturize the flexible member A21 with a high spring constant and make the characteristic frequency f small, providing a joint having a low load inertia. Here, the load inertia is an inertia in the robot joint mechanism and members ranging from a first rotation axis of the joint, using the robot joint mechanism A, to the joint having a second rotation axis which can be in parallel to the first rotation axis.

In the robot joint mechanism A, the speed-increasing converting mechanism A2 for transmitting the output through the elastic deformation is installed between the drive power source A1 and the load member A3, making the spring constant of the member elastically deformed in the speed-increasing converting mechanism A2 large. In other words, this improves a transmission performance of the force, improving the response. Further, a quantity of deformation at the elastically deformed member can be decreased. Thus, the response and the space efficiency can be improved.

Further, if the load member A3 impacts an obstacle or the like, the impact is reduced by the speed-increasing converting device A22, which suppresses a failure in the drive power source A1, i.e., improves an impact resistance.

### First Embodiment

Structure of Robot R

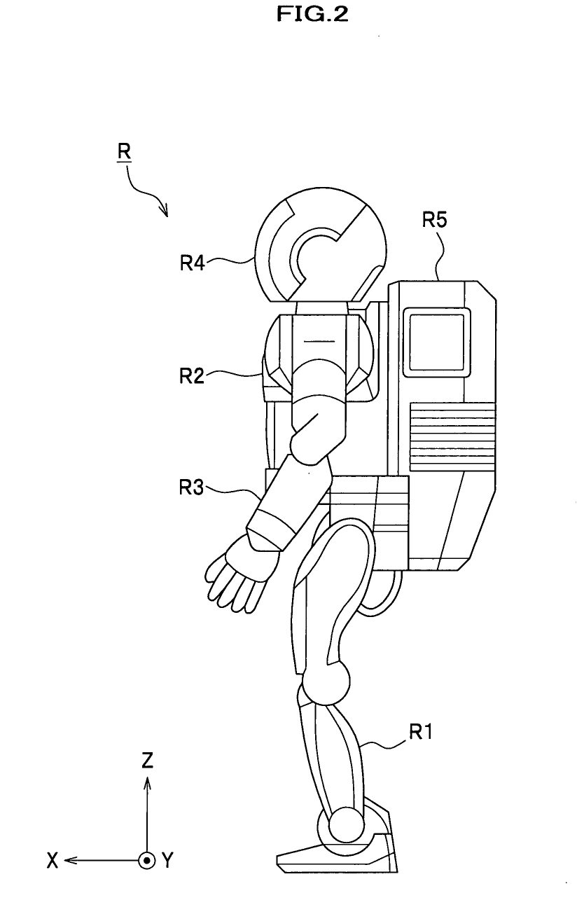

Next, will be described a robot R using the robot joint mechanism according to the present invention. In the blow description, it is assumed that a forward-backward direction of the robot R is defined as an X axis; the right-left direction, as Y axis; and an up-down direction, as a Z axis (see FIG. 2). The robot R in the embodiment of the present invention is an autonomous type of two-legged robot.

FIG. 2 shows a side view of the robot R using the robot joint mechanism according to the present invention. As shown in FIG. 2 (only left side is shown in FIG. 2), the robot R has two legs R1 for standing up, moving (walking, running, and the like), an upper body R2, two arms R3, and a head R4 and can move autonomously. Further, the robot R has a controller unit R5 for controlling operations of the legs R1, the upper body R2, the arms R3, and the head R4 in a form of shouldering the controller unit R5 on the back of the upper body R2.

Drive Mechanism of Robot R

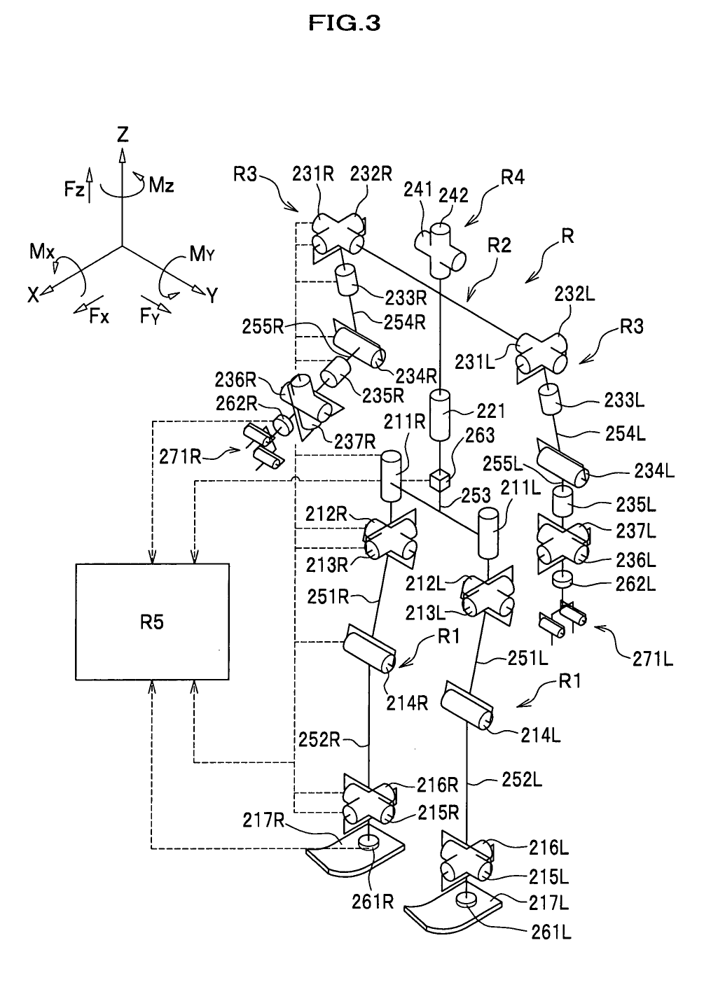

Next will be described a drive mechanism of the robot R. FIG. 3 show a perspective view of the drive mechanism of the robot R shown in FIG. 2. Joints shown in FIG. 3 are depicted in which electric motors are exemplified for driving the joints.

Legs R1

As shown in FIG. 3, each of right and left legs R1 has six joints 211R(L) to 216R(L). Among twelve joints of the right and left legs R1, there are:

Z hip joints 211R and 211L (hereinafter, “L” denotes a right part of the robot R, “R” denotes a left part of the robot R, and “Z” (“X”, and “Y”) denotes a pivoting axis) for pivoting the legs relative to the hip (a junction member between the legs R1 and the upper body R2) about the Z axis;

Y hip joints 212R and 212L for pivoting the legs about a pitching axis (Y axis);

X hip joints 213R and 213L for pivoting the legs about a rolling axis (X axis);

knee joints 214R and 214L for pivoting the lower legs about a pitching axis (Y axis);

Y ankle joints 215R and 215L for pivoting the feet about a pitching axis (Y axis); and

X ankle joints 216R and 216L for pivoting the feet about a rolling axis (Y axis). Attached to lower ends of the legs R1 are feet 217R and 217L through the Y ankle joints 215R and 215L and the X ankle joints 216R and 216L.

Thus, the leg R1 includes the Z hip joint 211R (L), the Y hip joint 212R (L), the X hip joints 213R (L), the knee joint 214R (L), the Y ankle joint 215R (L), and the X ankle joint 216R (L). Thigh links 251R (L) connects the Z hip joint 211R (L), the Y hip joint 212R (L), and the X hip joints 213R (L) to the knee joint 214R(L), and lower leg link 252R (L) connects the knee joint 214R (L) to the Y ankle joint 215R (L) and the X ankle joint 216R (L).

Upper Body R2

As shown in FIG. 3, the upper body R2 is a trunk of the robot R and connected to the legs R1, the arms R2, and the head R4. More specifically, the upper body R2 (an upper body link 253) is connected to the legs R1 through the Z hip joint 211R (L) to the X hip joints 213R (L). The upper body R2 is connected to the arms R3 through shoulder joints 231R (L) to 233 R (L) mentioned later. The upper body R2 is connected to the head R4 through a Y neck joint 241 and a Z neck joint 242.

Further, the upper body R2 has a backbone joint 221 for rotating the upper body R2 about the Z axis.

Arm R3

As shown in FIG. 3, each of the left and right arms R3 has seven joints 231R (L) to 237R (L). Among fourteen left and right joins there are:

Y shoulder joints 231R and 231L for pivoting the arms R3 about a pitching axis (Y axis) relative to the shoulder (a member connecting the arms 3 to the upper body R2);

X shoulder joints 232R and 232L for pivoting the arms R3 about a rolling axis (X axis) relative to the shoulder;

Z shoulder joints 233R and 231L for pivoting the arms R3 about a rotating axis (Z axis) relative to the shoulder;

elbow joints 234R and 234L for pivoting the lower arms about a pitching axis (Y axis) relative to the upper arms (a member connecting the shoulder to the lower arm);

arm joints 235R and 235L for rotating the wrist (about the Z axis);

Y wrist joints 236R and 236L for pivoting the hands about a pitching axis (Y axis); and

X wrist joints 237R and 237L for pivoting the hands about rolling axis (X axis).

Attached to tips of the arms R3 are hands (griping members) 271R and 271L.

Thus, the arm R3 includes the Y shoulder joint 231R (L); the X shoulder joint 232R (L), the Z shoulder joint 233R (L), the elbow joint 234R (L), the arm joint 235R (L), the Y wrist joints 236R (L), and the X wrist joint 237R (L). An upper arm link 254R (L) connects the shoulder joints 231R (L) to 233R(L) to the elbow joints 234R (L). A lower arm link 255R (L) connects the elbow joint 234R (L) to the wrist joints 236R (L) and 237R (L).

Head R4

As shown in FIG. 3, the head R4 includes a Y neck joint 241, at the neck (a member connecting the head R4 to the upper body R2), for pivoting the head R4 about the Y axis, and a Z neck joint 242 for pivoting the head R4 about the Z axis. The Y neck joint 241 is provided for determining a tilt angle of the head R4 and the Z neck joint 242 is provided for determining a panning angle of the head R4.

Thus, the left and right legs R1 have total twelve variances. Thus, driving the twelve joints 211R (L) to 216R (L) to have suitable angular movements and timings provides desired movements of the legs R1 which provides a desired traveling of the robot R in a three-dimensional space. Further the left and right arms R3 have fourteen variances. Thus, driving the fourteen joints 231R (L) to 237R (L) with suitable angular movements and timings provides desired movements of the arms R3, which enables the robot R to conduct a desired operation.

Provided between the ankle joints 215R (L) and 216R (L) and the feet 217R (L) is a known six-axis sensor 261R (L). The six-axis sensor 261R (L) detects three direction force components Fx, Fy, and Fz of a reaction force by a floor acting the robot R and three direction moment components Mx, My, and Mz.

Provided between Y wrist joints 236R (L) and the X wrist joint 237R (L) and the gripping member 271R (L) is a known six-axis sensor 262R (L). The six-axis sensor 262R (L) detects three direction force components Fx, Fy, and Fz of a reaction force acting the grip member 271R (L) of the robot R and three direction moment components Mx, My, and Mz.

Provided in the upper body R2 is an inclination sensor 263 which detects an inclination angle of the upper body R2 to a gravity axis (Z axis) and an angular velocity.

The electric motors at joints move the thigh link 251R (L), the lower leg link 252R (L), and the like relative thereto through a speed reducing mechanism such as harmonic drive gearings 93 and 94 shown in FIG. 4 for reducing the rotational speed. An angle at each joint is detected by a joint angle detector, such as a rotary encoder.

The controller unit R5 houses a control circuit 200, a battery (not shown), and the like.

Detection data from respective sensors 261R (L), 262R (L), 263R (L) and the like are sent to the control circuit 200 in the controller unit R5. The electric motors operate in response to drive command signals from the control circuit.

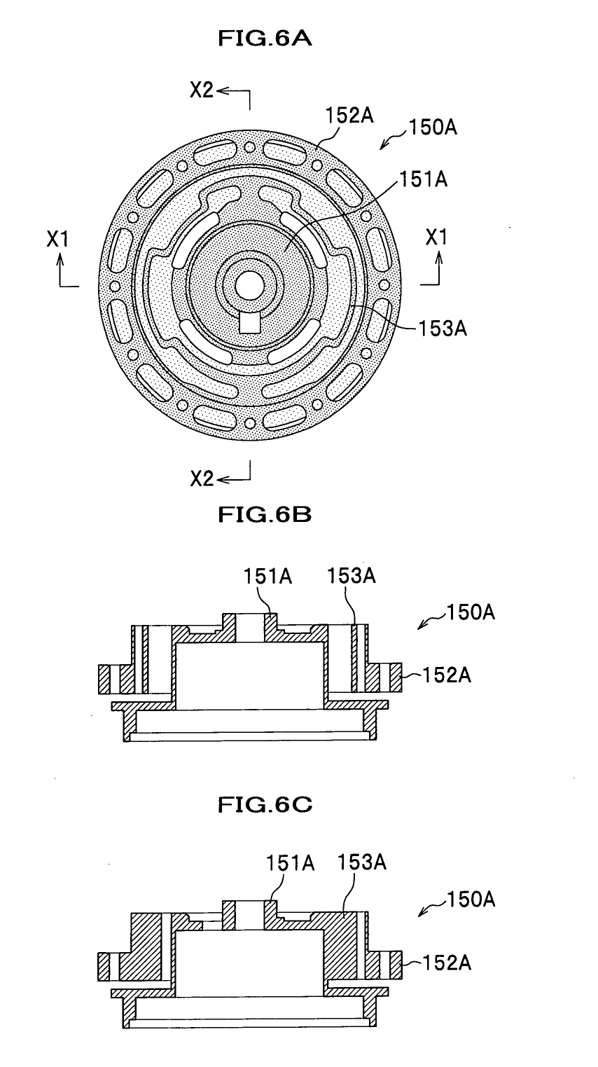

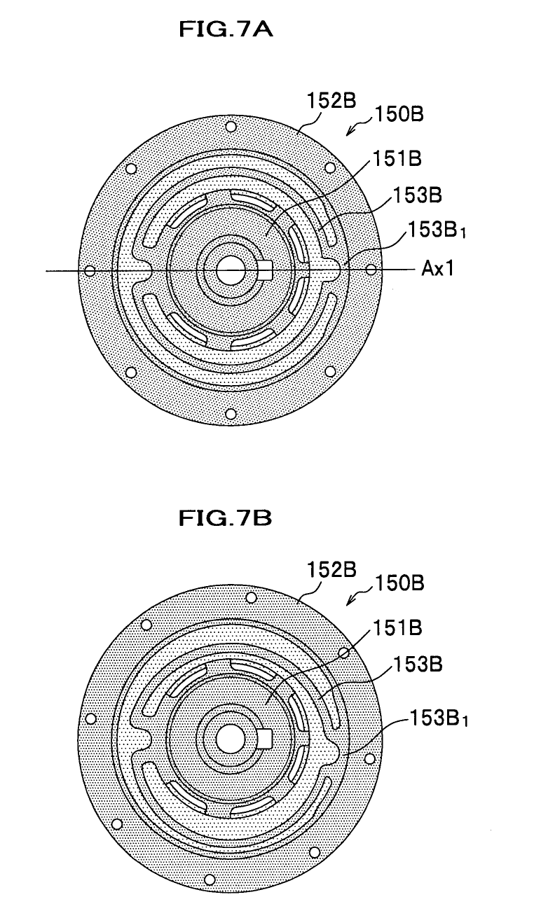

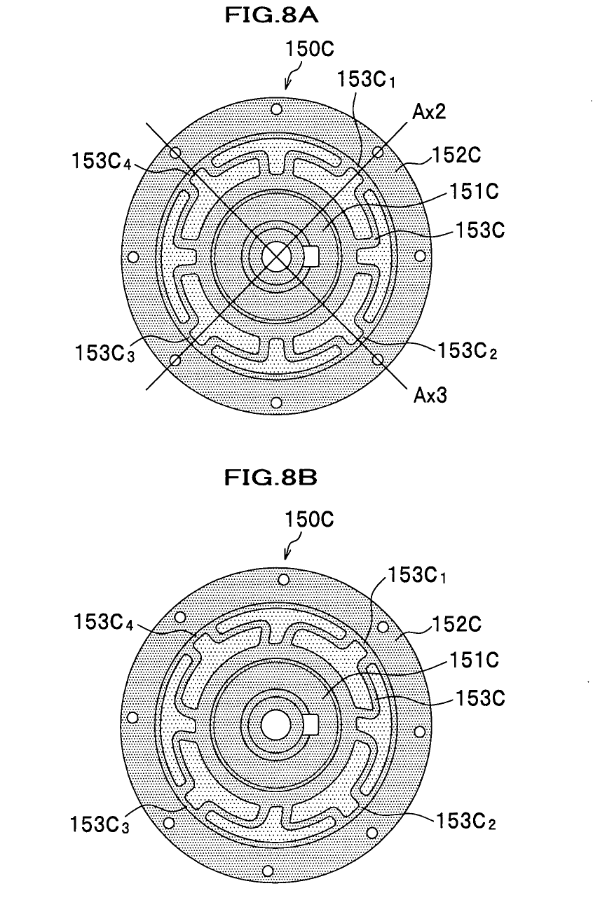

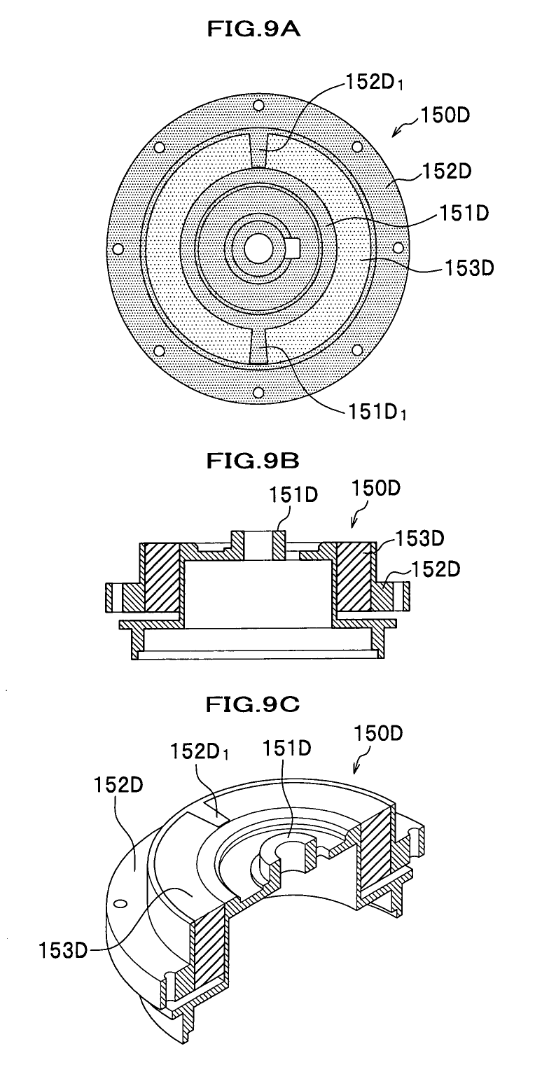

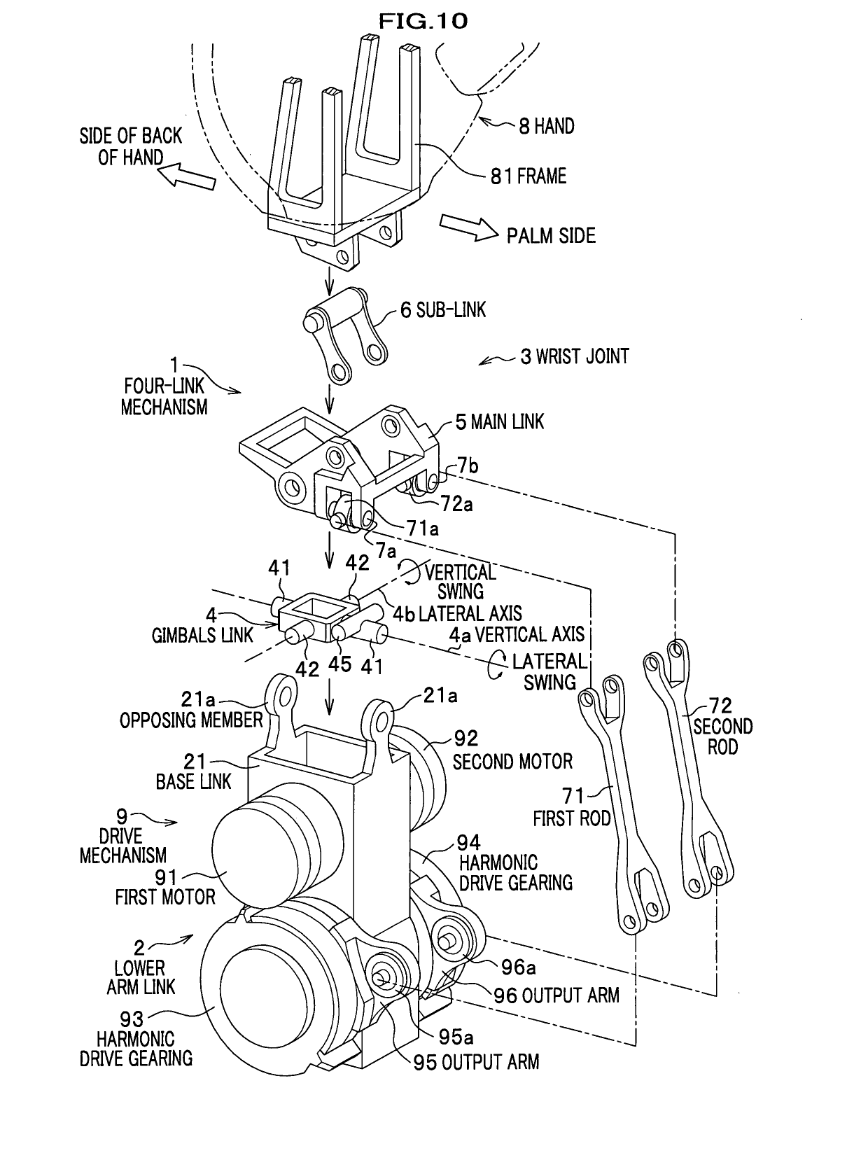

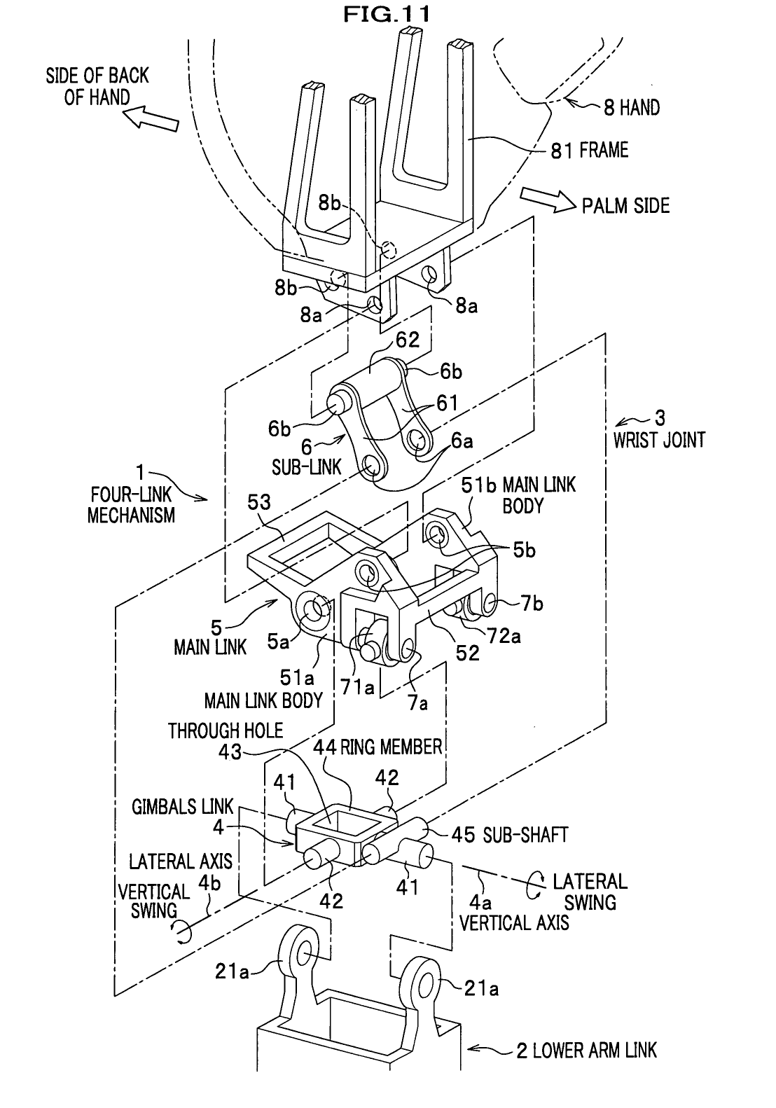

With reference to drawings will be described the first embodiment of the present invention. FIG. 4 shows a perspective view illustrating a joint structure of the lower arm and the hand. FIG. 5A shows a partially-sectional view of a part shown in FIG. 4. FIG. 5B shows a perspective view illustrating an annular spring. FIG. 6A is a plan view of the annular spring. FIG. 6B is a sectional view, taken along line of X1-X1 shown in FIG. 6A. FIG. 6C is a sectional view, taken along line of X2-X2 shown in FIG. 6A. FIG. 7A shows a view of a modification example of an annular spring having one-axis symmetry, and FIG. 7B is a drawing for illustrating a twist operation to describe the annular spring shown in FIG. 7A. FIG. 8A shows a view of another modification example of an annular spring having two-axis symmetry, and FIG. 8B is a drawing for illustrating a twist operation to explain twisting in annular spring. FIG. 9 A is a plan view, FIG. 9B is a side cross-sectional view, and FIG. 9B is a side cross-sectional view, and FIG. 9C is a perspective cutaway view of a further modification example of the annular spring. FIG. 10 is an exploded perspective view of a main part shown in FIG. 4. FIG. 11 is an exploded perspective view for explaining connection relations in the joints of the robot R according to the present invention.

In the embodiments of the present invention, the robot joint mechanism according to the present invention is exemplified in the joint mechanism (the Y wrist joints 236R (L) and the X wrist joint R (L) and the joint mechanism for rotating the lower arm (arm joints 235R (L) shown in FIG. 3). However, the present invention is unlimited to this, but may be applicable to the joint mechanisms of the robot R for the ankles, the arm, legs, and connecting members for connecting links of an industrial robot. The joint mechanism of the wrist, and the rotation joint of the lower arm of the robot R will be described in this order.

Further, the robot joint mechanism according to the present invention is applied to the Y neck joints 241 and the Z neck joint 242 to prevent vibration and an impact on a side of the upper body R2 to transmit to the head R4, which can suppress deterioration in images shot by cameras in the head 4.

Joint Mechanism of Wrist

The joint mechanism of the wrist of the robot R according to the first embodiment of the present invention includes, as shown in FIG. 4, a lower arm link 2 as a robot link, the wrist joint 3 connected to the lower arm link 2, a hand (hand links) 8 which is a connected member connected to the wrist joint 3, and a drive mechanism 9 for conducting a vertical swing and a lateral swing.

More specifically, as shown in FIG. 10, opposing members 21a and 21a formed on the lower arm link 2 support vertical shafts 41 of a gimbals link 4 to allow the gimbals link 4 to freely rotate in the lateral swing direction. Further, a main link 5 is pivotally connect to the lateral shafts 42 of the gimbals link 4, a sub-link 6 is pivotally connected to a sub-shaft 45 of the gimbals link 4 so that the main link 5 and the sub-link 6 are pivotally supported in the vertical swing direction. Thus, the hand 8 pivotally connected to the main link 5 and the sub-link 6 can swing in the vertical swing direction and the lateral swing direction (also see FIG. 11).

The lower arm link 2 includes a base link 21 as a base of the lower arm link 2 and a drive mechanism 9 fixed to the base link 21. Formed on the base link 21 are the opposing members 21a and 21a for pivotally supporting the vertical shaft 41 of the gimbals link 4.

In this embodiment, to clearly describe operations in the joint structure of the wrist, other structural elements such as a control mechanisms, sensors, and electric cables are omitted in the drawings.

The drive mechanism 9 includes: a first motor 91 and a second motor 92 as a part of the drive power source; harmonic drive gearings 93 and 94 coupled to the first motor 91 and the second motor 92 with a drive belt V (see FIG. 5A); output arms 95 and 96 connected to an output shaft of the harmonic drive gearings 93 and 94 through an annular spring 150 (see FIGS. 5A and 5B); a first rod 71 and a second rod 72 having one ends connected to the output arms 95 and 96 through ball and socket joints 95a and 96a as universal joints with a twistable function and the other ends connected to the main link 5 through universal joints 71a and 72a as universal couplings, respectively.

In the embodiment, rotational driving is provided with motors. However, the present invention is unlimited to this. For example, this is provided by a linear driving with a hydraulic cylinder, a ball screw, and the like.

With reference to FIGS. 5 and 6, will be described in detail the drive mechanism 9.

The drive mechanism 9 has similar structures on the both sides of the first motor 91 and the second motor 92, and thus only the side of the first motor 91 will be described.

As shown in FIG. 5A, fixed to an output shaft 91a of the output shaft 91 is a pulley P1. Wrapped around the pulley P1 and a pulley P2 is a belt V.

The pulley P2 is fixed to a wave generator 93b as an input of the harmonic drive gearing 93.

An output of the harmonic drive gearing, i.e., a flex spline 93c, is fixed to a center member 151A of the annular spring 150A.

A peripheral member 152A of the annular spring 150A is fixed to the output arm 95.

Further, in FIG. 5A, a circular 93a of the harmonic drive gearing 93 is fixed to the base link 21, and a housing S supports a shaft of the wave generator 93b.

Further, the drive mechanism 9 includes encoders ENC1 and ENC2. The encoder ENC1 detects a rotary position change in the motor 91, and the encoder ENC2 detects a position change of the output arm 95.

Detection results of the encoders ENC1 and ENC2 are supplied to the control circuit in the controller unit R5. The control circuit calculates a torsion quantity of the annular spring 150 on the bases of the detection results of the encoders ENC1 and ENC2 to control driving of the joints on the basis of the calculated torsion quantity, suppressing a resonance of the annular spring.

As shown FIG. 6, the annular spring 150A is a member which is a circle when viewed in an axial direction of the annular spring 150A with an flexibility in a torsion direction and includes a center member 151A provided at a center thereof, a peripheral member 152A provided around the center member 151A in radial direction, an flexible member 153A connected to the center member 151a and the peripheral member 152A for elastic deformation.

The center member 151A is fixed to the flex spline 93c which is an output end of the harmonic drive gearing 93, and the peripheral member 152A is fixed to the output arm 95.

The flexible member 153A is formed integrally with the center member 151A and the peripheral member 152A with the same material, such as SNCM (nickel-chrome molybdenum steel), SCM (chrome molybdenum steel) and has an elastic deformation in a torsion direction in accordance with a torque inputted from the center member 151A or the peripheral member 152A. More specifically, the flexible member 151 is formed to have thin plates folded zigzag.

The robot joint mechanism having the annular spring 150A occupies a smaller space in the axial direction than that provided in a case where a torsion bar is used. Further, in comparison with the case where the torsion coil springs are used, the robot joint mechanism with the annular spring 150A requires no pre-load, which removes the necessity of two torsion coil springs and thus, allows use of only one spring (annular spring) having a strength identical with a maximum load torque. In addition, the annular spring 150A has substantially no hysteresis because of no contact members.

With reference to FIGS. 7 to 9, will be described modification examples of the annular springs.

As shown in FIG. 7A, an annular spring 150B as a modification is a member which is circular when viewed in an axial direction and has a flexibility in a torsion direction. The annular spring 150B includes a center member 151B provided at a center thereof, a peripheral member 152B formed around the deter member 151B, and a flexible member 153B connected to the center member 151B and the peripheral member 152 for elastic deformation. The center member 151B, the peripheral member 152B, and the flexible member 153B have substantially identical functions with the center member 151A, the peripheral member 152A, and the flexible member 153A, respectively. More specifically, the flexible member 153B is formed to have thin plates folded zigzag.

The flexible member 153B is connected at one location thereof to the peripheral member 152B.

The annular spring 150B is line symmetry about at least one axis on a cross section orthogonal with a rotary axis. More specifically, the annular spring 150B is line-symmetrical about an axis Ax1 intersecting the rotation axis of the annular spring 150B and a connection member 153B₁.

As shown in FIG. 7B, in the annular spring 150B the flexible member 153B shows an elastic deformation in a torsion direction when a torque is applied to either of the center member 151B or the peripheral member 152B.

In the robot joint mechanism including the annular spring 150B, the flexible member 153B is line-symmetrical about at least one axis on a cross section orthogonal with a rotation axis of the annular spring 150B, which allows the annular spring to have a simple structure. Further, this equalizes spring constants in clockwise and counterclockwise torsion directions, i.e., makes elastic properties in the clockwise and counterclockwise torsion directions symmetry.

As shown in FIG. 8A, an annular spring 150C of a modification is a member which is circular when viewed in an axial direction and flexible in a torsion direction, and includes a center member 151C, a peripheral member 152C formed around the center member 151C in a radial direction, a peripheral part 152C, and a flexible member 153C, connected to the center member 151C and the peripheral member 152C, for elastic deformation. The center member 151C, the peripheral member 152C, and the flexible member 153C have substantially identical functions with the center member 151A, the peripheral members 152A, and the flexible member 153A, respectively. More specifically, the flexible member 153A is formed to have thin plates folded zigzag.

The flexible member 153C is connected to the peripheral member 152C at four locations with connecting members 153C₁, 153C₂, 153C₃, and 153C₄.

The annular spring 150C is line-symmetric about two axes on a cross section orthogonal with a rotation axis thereof. The annular spring 150C is line-symmetric about an axis Ax2 intersecting a rotary axis of the annular spring 150C and crossing the connecting points 153C₁ 153C₃ and an axis Ax2 intersecting the rotary axis and crossing the connecting points 153C₂ and 153C₄.

As shown in FIG. 8B, in the annular spring 150C, when a torque is applied to either of the center member 151C or the peripheral member 152C, the flexible members 153C show elastic deformations in a torsion direction.

The robot joint mechanism having the annular spring 150C is line-symmetrical about two axes intersecting each other. This structure prevents a torque which may be caused by a shift of the rotary axes of the center member 151C and the peripheral member 152C to suppress an error in torque detection.

In other words, the flexible member of the annular spring may be formed to have n-fold rotational symmetric structure regarding the rotary axis of the annular spring (n being a natural number more than one).

As shown in FIG. 9A, an annular spring 150D of a modification is a member, which has a flexibility in a torsion direction and is circular when viewed in an axial direction thereof, and includes a center member 151D formed at a center thereof, a peripheral member 152D formed therearound, and a flexible member 153D connected to the center member 151D and the peripheral member 152D for elastic deformation. The center member 151D, the peripheral member 152D, and the flexible member 153D have substantially identical functions with the center member 151A, the peripheral member 152A, and the flexible member 153A.

The center member 151D includes a support plate 151D₁ outwardly extending therefrom at a predetermined location thereof, and the peripheral member 152D includes a support plate 152D₁ inwardly extending therefrom at a predetermined location thereof (opposite to the support plate 151D₁).

The flexible member 153D is made of rubber unlike the flexible members 153A, 153B, and 153C. Outer and inner circumference surfaces of the flexible member 153D are fixed to the center member 151D and the peripheral member 152D by adhering or the like.

The support plates 151D₁ and 152D₁ support the flexible member 153D to prevent the center of the annular spring 150D from shifting. Adjusting the number of the support plates determines a spring constant and a strength of the annular spring 150D.

As the flexible member 153D, an elastic fluid such as air may be used. In this case, the elastic fluid is packed with the support plates 151D₁ and 152D₁.

Without using the support plates 151D₁ and 152D₁, the annular spring 150D may have such a structure that protrusions and sockets which can be fitted into each other are formed on contact surfaces between the center member 151D and the flexible member 153D and between the peripheral member 152D and the flexible member 153D for engagement.

The annular springs 150A, 150B, and 150C can have improved damping properties by injecting a viscid elastic material such as a rubber and air into gaps formed in the flexible members 153A, 153B, and 153C.

Further, the annular springs 150A, 150B, and 150C may have such a heat exchanging structure as to allow a fluid to pass through a channel or passage formed in the flexible members 153A, 153B, and 153C.

In addition, a torque acting the annular spring 150 can be measured by attaching a displacement sensor such as a strain gage to the flexible members 153A, 153B, 153C, and 153D.

As shown in FIGS. 10 and 11, the wrist joint 3 includes a gimbals link 4 pivotally supported by the opposing members 21a and 21a of the link of the lower arm, the main link 5 supported by the lateral shaft 42 of the gimbals link 4, and the sub-link 6 disposed across the main link 5.

The gimbals link 4 includes a ring member 44, having a rectangular frame shape, disposed at a center thereof and the vertical shafts 41 and the lateral shafts 42 of which axis orthogonally crossing an axis of the vertical shafts 41, wherein the vertical shafts 41 and lateral shafts 42 extend from respective sides of the ring member 44.

The ring member 44 has a rectangular ring shape (frame) having a through hole 43 and is disposed at a center of the gimbals link 4. The ring member 44 has the vertical shafts 41 outwardly extending from opposing sides thereof and the lateral shafts 42 outwardly extending from the other opposing sides thereof.

The vertical shafts 41 of the gimbals link 4 function as a pivoting axis for the lateral swing movement of the hand 8, namely, a vertical axis 4a. The lateral shafts 42 of the gimbals link 4 function as a pivoting axis for the vertical movement of the hand 8, namely, a lateral axis 4b. Both ends of the vertical shaft 41 are pivotally supported by opposing members 21a and 21a of the base link 21 to allow a rotary movement of the gimbals link 4.

Further, the gimbals link 4 has the through hole 43 at a center thereof, which allows electric cables and hydraulic or air tubes to pass therethrough. Thus, even if the gimbals link 4 rotates, the cables or the like do not impede movements of the joints, which makes a movable angle range of the joints large. Further, this prevents an excessive force from acting on the cables or the like, reducing possibility of disconnection of the cables.

Further, the sub-shaft 45 is disposed on the vertical shaft 41 so as to be in parallel to the lateral shaft 42. The sub-shaft 45 pivotally supports the sub-link mentioned later for the vertical swing movement.

In the embodiment, the gimbals link 4 has, in a plan view, a cross shape of which center has the through hole 43. However, the present invention is unlimited to this. The gimbals link 4 may have other shape as long as the gimbals link 4 has the vertical axis 4a for the lateral swing movement and the lateral axis 4b for the vertical swing movement. For example, a disk shape may be adopted.

As shown in FIGS. 10 and 11, the main link 5 is formed to have a rectangular frame of which center has a large through hole by integrally connecting a pair of main link bodies 51a and 51a, having a triangle shape, opposing to each other with connecting members 52 and 53. The sub-link 6 mentioned later is arranged inside the main link 5 having the frame shape so as to be connected to the sub-shaft 45 of the gimbals link 4. In this structure, the main link 5 stably holds the hand 8 connected to the main link 5 using the sub-link 6 housed therein with a good balance by providing a span, extending along the lateral axis 4b, serving as a support of the hand 8.

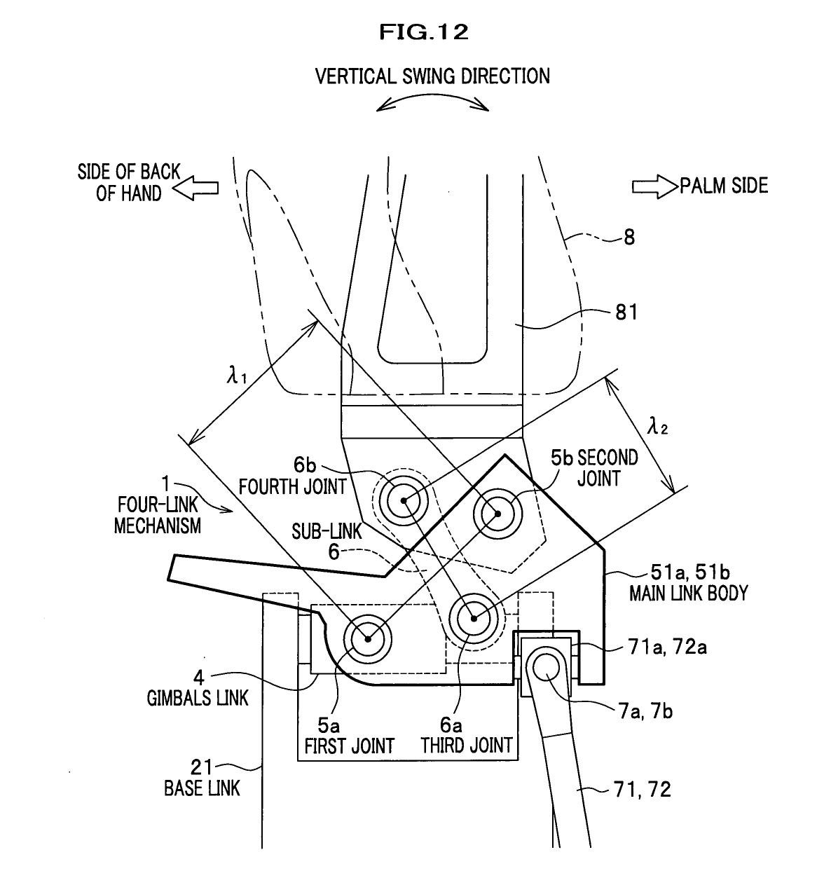

Each of the main link bodies 51a and 51a has a first joint 5a and a second joint 5b (see FIGS. 11 and 12), adjacent to one side of a triangle shape of the main link 5, the first joint 5a and the second joint 5b forming a four-link mechanism 1. The first joints 5a connect the main link 5 at one end of the main link 5 to the lateral shafts 42 of the gimbals link 4. The second joints 5b are provided for connecting the main link 5 at the other end of the main link 5 to a frame 81 of the hand 8 with main link joint holes 8a. A length between the first joint 5a and the second joint 5b is determined as a link length λ₁ (see FIG. 12).

Connected to another side of the triangle shape of the main link body 51a (51a) is a first rod 71 (a second rod 72) through a universal joint 71a (72a). More specifically, the first rod 71 is connected to the main link body 51a at a first connecting point 7a (a position to which the universal joint 71a is connected), and the second rod 72 is connected to the main link body 51a at a second connecting point 7b (a position to which the universal joint 72a is connected).

The first and second connecting point 7a and 7b are disposed to have distances from the lateral axis 4b and the vertical axis 4a of the gimbals link 4 which are identical with each other, as well as a line connecting the first connecting point 7a to the second connecting point 7b is in parallel with the lateral axis 4b, in an assembled condition.

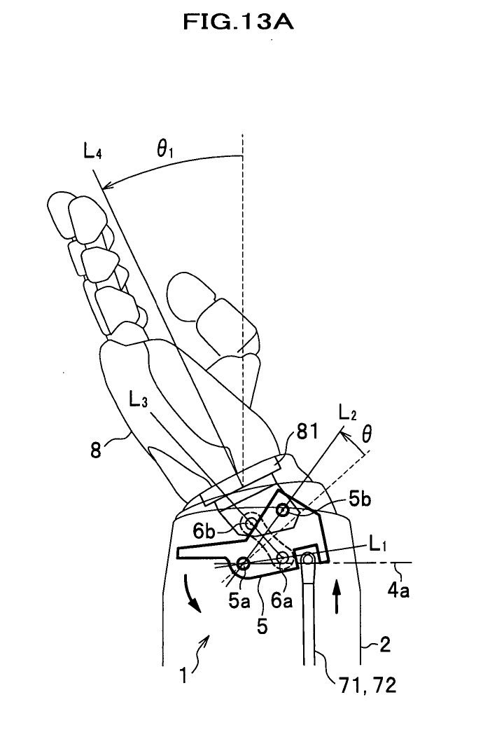

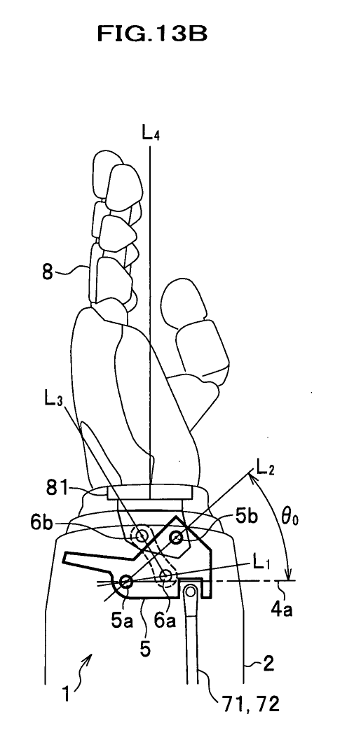

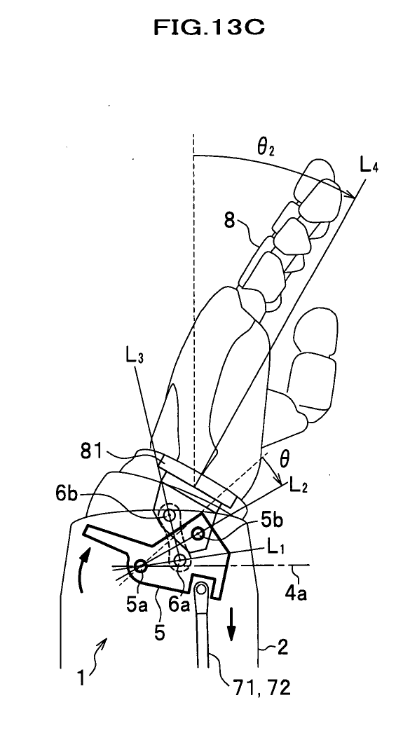

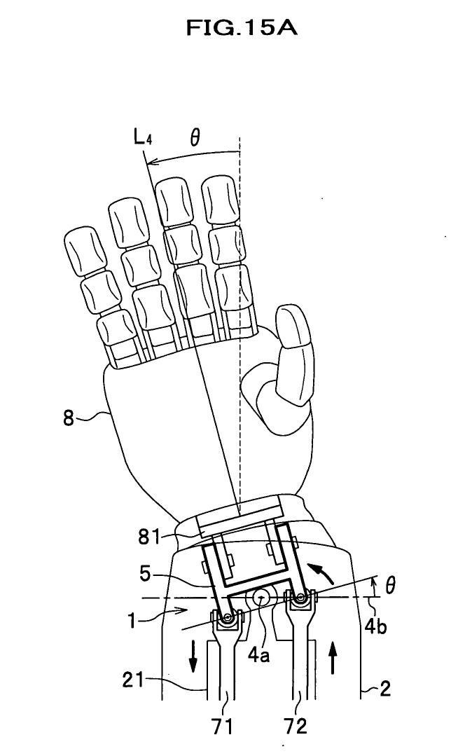

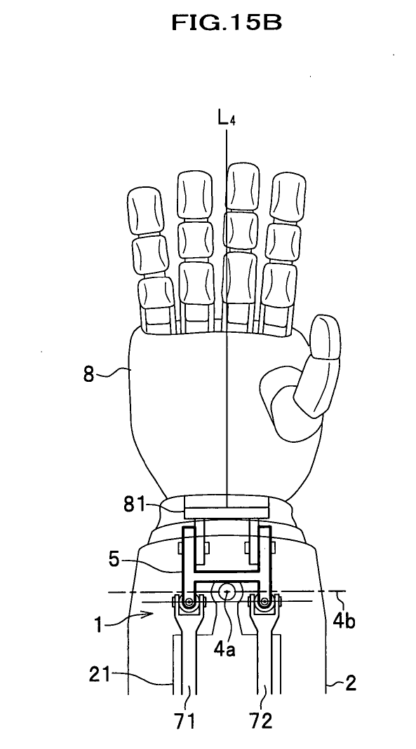

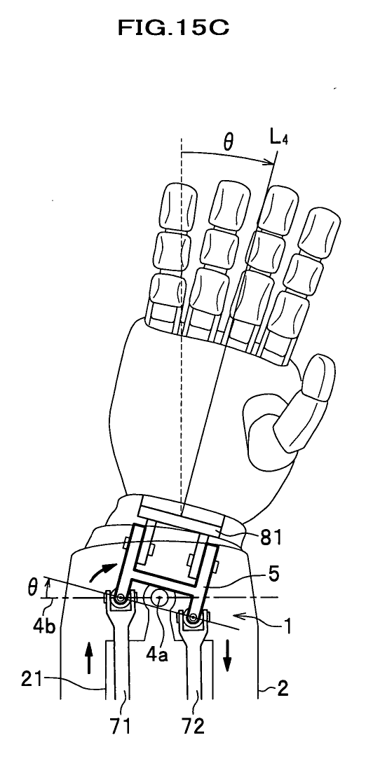

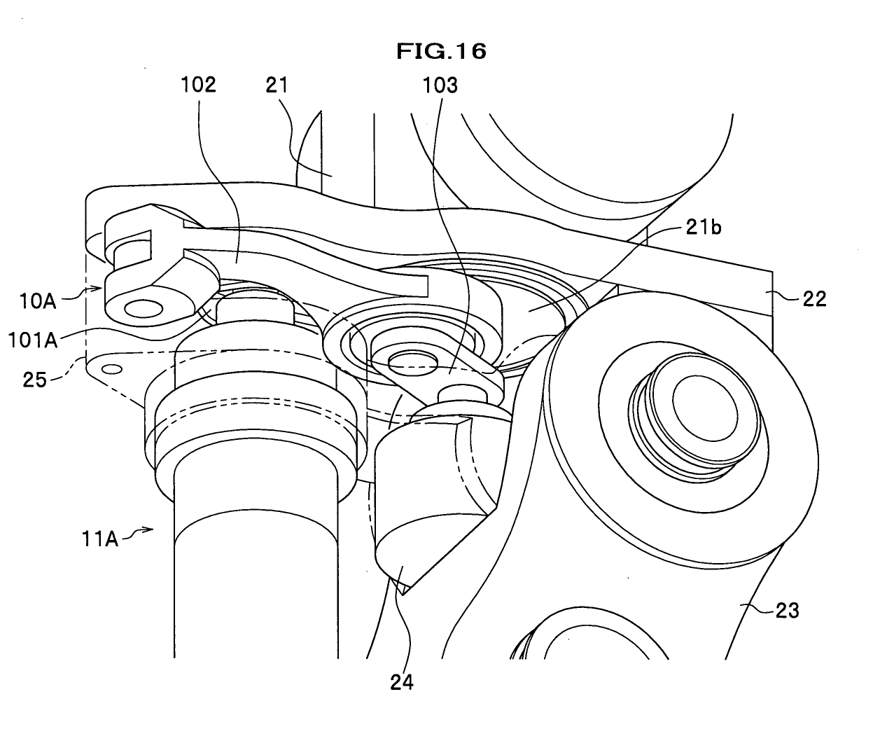

In this structure, forward or backward movements of the first rod 71 and the second rod 72 by the same distance provide a vertical swing of the main link 5 (see FIGS. 13A to 13C). Further, a forward or backward movement of one of the first and second rods 71 and 72 and a backward or forward movement of the other can swing the main link 5 in the lateral swing direction (see FIGS. 15A to 15C).

The “forward movement” means a movement of the first rod 71 (the second rod 72) approaching the hand 8. The “backward movement” means a movement of the first rod 71 (the second rod 72) going away from the hand 8.

The sub-link 6 is formed with a pair of sub-link bodies 61 and 61 opposing to each other and a connecting member 62 which integrally connects the sub-link bodies 61 and 61, and is housed within the main link 5 having the rectangular frame including the main link bodies 51a and 51a opposing to each other and connecting members 52 and 53.

In this structure, the sub-link 6 provides the span along the lateral axis 4b with an integrated body including the opposing sub-link bodies 61 and 61 connected with the connecting member 62 to support the hand 8 connected to the sub-link 6 with a sufficient stiffness to prevent backlash from being generated.

Further, the sub-link 6, at one end, is pivotally connected to the sub-shaft 45 of the gimbals link 4 to form a third joint 6a of the four-link 1 (see FIG. 12) and forms, at the other end, a fourth joint 6b which is pivotally connected to the hand 8 (see FIG. 12). The third joint 6a and the fourth joint 6b provide a link length of λ₂ therebetween (see FIG. 12).

As shown in FIG. 11, the hand 8 includes the frame 81 as a base. The frame 81 has a pair of main link joint holes 8a and 8a pivotally connected to the second joints 5b and 5b of the main link 5 and a pair of sub-link joint holes 8a and 8a pivotally connected to the fourth joints 6b and 6b of the sub-link 6.

With reference to FIG. 12 will be described the four-link mechanism 1 including the main link 5 and the sub-link 6. FIG. 12 is a side view of the robot joint mechanism according to the first embodiment to describe the four-link mechanism 1.

As shown in FIG. 12, the four-link mechanism 1 includes the main link 5 for coupling the gimbals link 4 to the hand 8 and a sub-link 6 so disposed as to cross the main link 5 in which first to fourth joints (5a, 5b, 6a, and 6b) are formed.

More specifically, the first joints 5a are provided, on the side of the hand 8, for joining the main link 5 to the gimbals link 4 and serve as a pivoting axis for swing of the main link 5 in the vertical swing direction. The second joints 5b are provided for joining the main link 5 to the frame 81 of the hand 8. The third joints 6a joint the sub-link 6 to the gimbals link 4 and serves as a pivoting axis in the vertical swing direction. The fourth joints 6b join the sub-link 6 to the frame 81 of the hand 8 on a side of the back of the hand 8.

More specifically, one end of the main link 5, at the first joints 5a, is joined to the lateral shafts 42 of the gimbals link 4 and, at the second joints 5b, to the main link joint hole 8a in the frame 81 of the hand 8 (see FIG. 11).

On the other hand, one end of the sub-link 6, at the third joints 6a, is joined to the sub-shaft 45, and the other end, at the fourth joint 6b, is joined to the sub-link joint holes 8b in the frame 81 of the hand 8 (see FIG. 11). Thus, the sub-link 6 is joined to the hand 8 such that a line between the third joint 6a and the fourth joint 6b of the sub-link 6 intersects a line between the first joint 5a and the second joint 5b of the main link 5.

In this embodiment, the second joints 5b are joined to the frame 81 of the hand 8 on a side of a palm of the hand 8, and the fourth joint 6b are joined to the frame 81 of the hand 8 on the side of the back of the hand 8. Thus, a positional relation between the second joints 5b and the fourth joints 6b determines a rotational angle (inclined angle) of the hand 8.

Further, the link length λ₁ of the main link 5 is longer than the link length λ₂ of the sub-link 6. Here, making the link length λ₁ of the main link 5 longer than the link length λ₂ is attributable to obtaining a larger pivoting range of the main link 5 and the sub-link 6.

As shown in FIG. 11, joined to the main link 5 are the first rod 71 and the second rod 72 through the universal joints 71a and 72a (see FIG. 10 also). The position where the first rod 71 is joined to the main link body 51a is a first joint point 7a, and the position where the second rod 72 is joined to the main link body 51a is a second joint point 7b.

The first joint point 7a and the second joint point 7b have distances from the lateral shaft 4b and the vertical shaft 4a of the gimbals link 4, which are identical with each other, and a line between the first joint point 7a and the second joint point 7b is in parallel to the lateral axis 4b.

Thus, for example, in FIG. 13A, the forward movement of only the first rod 71 generates a moment pivoting the hand 8 toward the side of the back of the hand 8 about the lateral axis 4b as well as a moment pivoting the hand about the vertical axis 4a clockwise when the palm is viewed. On the other hand, a forward movement of only the second rod 72 generates a moment pivoting the hand 8 about the lateral axis to the back of the hand as well as a moment pivoting the hand about the vertical axis 4a counterclockwise.

Thus, forward movements of the first and second rods 71 and 72 by the same distance pivot the main link 5 in the vertical direction to the back of the hand 8. Further, backward movements of the first and second rods 71 and 72 by the same distance pivot the main link 5 in the vertical direction to the palm.

On the other hand, the forward movement of the first rod 71 and the backward movement of the second rod 72 pivot the main link 5 clockwise in the lateral swing direction (see FIG. 15C). The backward movement of the first rod 71 and the forward movement of the second rod 72 pivot the main link 5 counterclockwise in the lateral swing direction (see FIG. 15A).

As mentioned above, the vertical swing movement and the lateral swing movement are provided by the forward or the backward movement of the first and second rods 71 and 72. The first and second rods 71 and 72 are independently driven by a first motor 91 and the second motor 92. Thus, cooperative driving by the two motors provides the vertical swing movement and the lateral swing movement of the hand 8, which can help in miniaturizing the motor and the joint structure of the robot. Further, synchronous movements of the first and second rods 71 and 72 provides the movements of the hand 8 in the vertical swing direction and the lateral swing direction, which makes the control easier and the movement of the hand smooth.

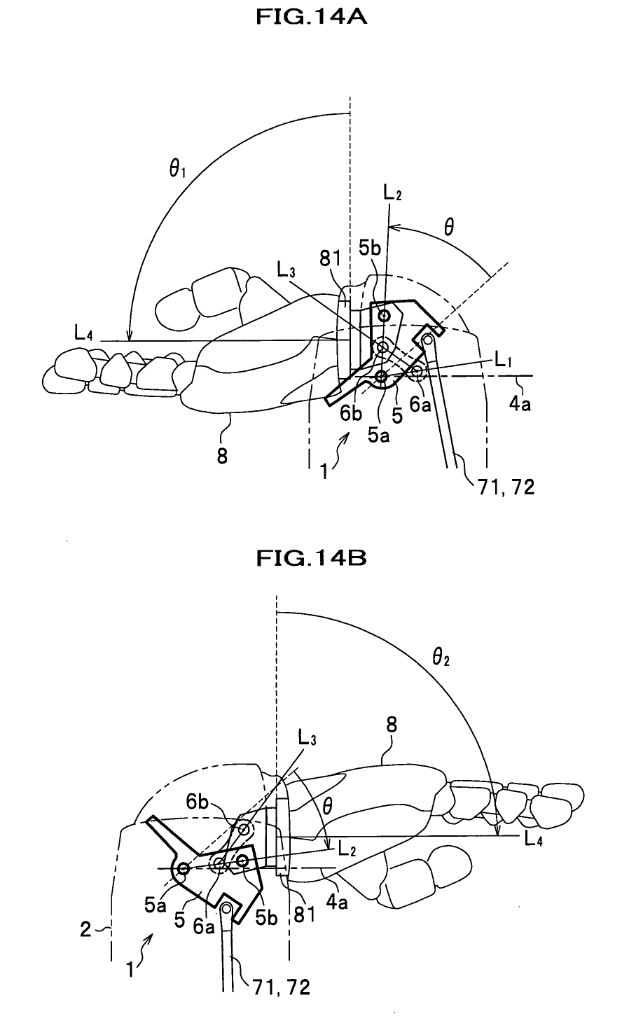

With reference to FIGS. 13A to 15C will be described an operation of the four-link mechanism 1 in the joint structure of the hand of the humanoid robot according to the first embodiment. FIGS. 13A to 13C are side views of the hand 8 and a wrist joint part 3 for explaining the vertical swing movement of the four-link mechanism 1. FIG. 13A shows a position in which the hand 8 turned to the back of the hand, FIG. 13B shows a position in which the hand 8 is straight with the arm link 2, and FIG. 13C shows a position in which the hand 8 turned to the palm. FIGS. 14A and 14B are side views of the hand 8 and the wrist joint part 3 for illustrating the hand turned by 90 degrees. FIG. 14A shows a position in which the hand 8 is turned to the back of the hand, and FIG. 14B shows a position in which the hand 8 is turned to the palm.

First, with reference to FIGS. 13A to 13C will be described the vertical swing movement.

It is assumed that a line between the first joint 5a and the third joint 6a is a base line L₁; a line between the first joint 5a and the second joint 5b is the main link L₂; a line between the third joint 6a and the fourth joint 6b is a sub-link line L₃; and a center axis of the hand 8 is L₄. Then, when the hand 8 is straight with the lower arm link 2, an angle of the main link L₂ with the vertical axis 4a of the gimbals link 4 (see FIG. 10) is θ₀.

In FIGS. 13A to 13C, because the first joint 5a and the third joint 6a are pivotally connected to the gimbals link 4 (see FIG. 10), the base line L₁ between the first joint 5a and the third joint 6a does not pivot in the vertical swing direction (see FIG. 12). Thus, this positional relation is unchanged among FIGS. 13A to 13C.

When the main link 5 is pivoted in a direction of the back of the hand 8 (counterclockwise in FIG. 13A) about the first joint 5a by θ from a status in which the hand 8 is straight with the lower arm link 2 by the forward movements of the first and second rods 71 and 72 by the same distance, the second joint 5b also pivots in the direction of the back of the hand. With the pivoting of the main link 5, the fourth joint 6b of the sub-link also pivots in the direction of the back of the hand about the third joint 6a.

During this operation, the second joint 5b of the main link 5 moves upward in FIG. 13A, pivoting the fourth joint 6b of the sub-link 6 downward to increase an inclination angle of the hand 8. As a result, as shown in FIG. 13A, the hand 8 pivots in the direction of the back of the hand 8 by θ₁ greater than θ in which a pivoting speed is being increased.

More specifically, regarding pivoting in the vertical swing direction, the pivoting angle θ₁ of the hand 8 is greater than the pivoting angle of the main link 5. In other words, only a small movement of the main link 5 largely inclines the hand 8.

Thus, the pivoting angle of the main link 5 is suppressed toward a minimum quantity, preventing an interference with other built-in parts during the pivoting of the main link 5. This provides a compact wrist joint structure with a wide pivoting angle of the hand 8.

Further, this structure provides an accelerated pivoting speed with the pivoting of the hand 8 and further inclination of the hand 8, which makes the pivoting the hand 8 quick with a high response and a sufficient movable range to provide a compact wrist joint structure.

For example, as shown in FIGS. 14A and 14B, although the hand 8 is pivoted to a pivoting angle of the human wrist, i.e., by 90 degrees, θ is only 46 degrees (see FIG. 14A). When the hand 8 is pivoted to the back of the hand 8, θ is only 32 degrees (see FIG. 14B). This shows that the pivoting angle of the main link 5 is small. This relation in pivoting angle between the hand 8 and the main link 5 is exemplified. Thus this relation may be changed in accordance with the joint of the robot R to which the robot link is applied.

Similarly, the backward movements of the first and second rods 71 and 72 by θ about the first joint 5a pivot the main link 5 in the direction of the palm (clockwise in FIG. 13B) from a status in which the hand 8 is straight with the lower arm link 2 as shown in FIG. 2 pivot the hand 8 in the direction of the palm of the hand 8 by an angle of θ₂ greater than θ as shown in FIG. 13C at an accelerated speed.

In this operation, because a link length λ₁ of the main link 5 is made greater than a rink length λ₂ of the sub-link 6, the angle of θ₂ becomes greater than θ₁ (see FIG. 12).

With reference to FIGS. 15A to 15C will be described the lateral swing movement.

FIGS. 15A to 15C are plan views for illustrating the lateral swing movement in the four-link mechanism according to the embodiment of the present invention. FIG. 14A shows a status in which the hand 8 is turned counterclockwise on FIG. 14A. FIG. 14B shows a status in which the hand 8 is straight with the low arm link 2. FIG. 14C shows a status in which the hand 8 is turned clockwise on FIG. 14C.

In the status in which the hand 8 is straight with the lower arm link 2 as shown in FIG. 15B, the center axis L₄ of the hand 8 and the lateral axis 4b of the gimbals link 4 (see FIG. 10) intersect orthogonally.

When the backward movement of the first rod 71 and the forward movement of the second rod 72 by the same distance from the status in which the hand 8 is straight with the lower arm link 2 to pivot the main link 5 counterclockwise by θ about the vertical axis 4a of the gimbals link 4, the hand 8 also turns in the same direction by θ as shown in FIG. 15A.

Similarly, the forward movement of the first rod 71 and the backward movement of the second rod 72 by the same distance from the status in which the hand 8 is straight with the lower arm link 2 pivot the main link 5 clockwise by θ about the vertical axis 4a of the gimbals link 4, pivoting the hand 8 in the same direction by θ as shown in FIG. 15C. In this operation, the pivoting angle θ in the lateral swing direction shown in FIG. 15C is identical with that shown in FIG. 15A.

With reference to FIGS. 13A to 15C will be described combinations of the vertical swing movement and the lateral swing movements.

As described above, the forward or backward movements of the first rod 71 and the second rod 72 by the same distance provide the vertical swing movement (see FIGS. 13A to 13C). A combination of the forward movement of the first rod 71 and the backward movement of the second rod 72 by the same distance and a combination of the backward movement of the first rod 71 and the forward movement of the second rod 72 by the same distance provide the lateral swing movement (see FIGS. 15A to 15C). Further, combinations of the vertical swing movement and the lateral movement provide a movement of the hand 8 slantwise with the vertical axis 4a and the lateral axis 4b, and a movement of the hand 8 of which tip moves circularly freely.

Joint Mechanism for Pivoting Wrist

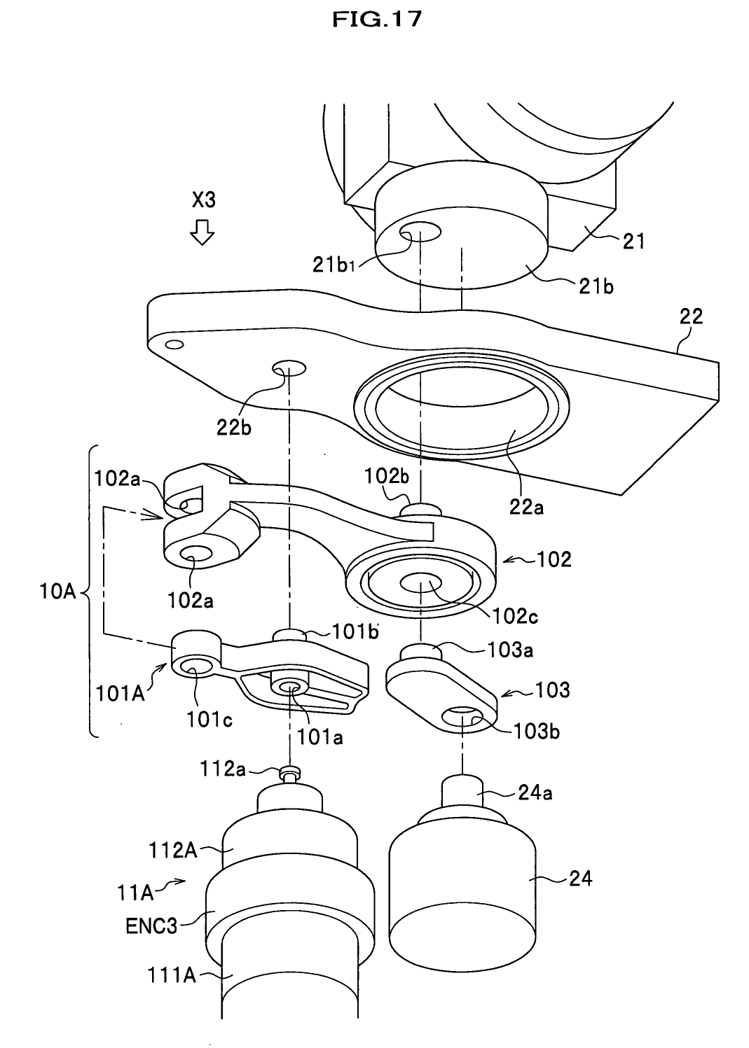

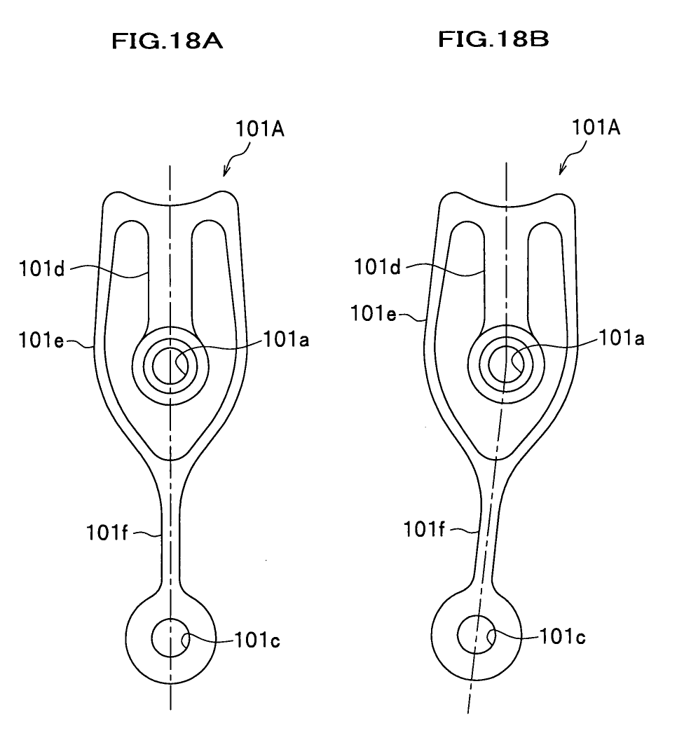

With reference to FIGS. 4, 16 to 18 will be descried a joint mechanism for pivoting the wrist of the robot R according to the embodiment of the present invention. FIG. 16 is a perspective view of the joint mechanism for pivoting the wrist of the robot according to the first embodiment of the present invention. FIG. 17 is an exploded perspective view of a main portion shown in FIG. 16. FIGS. 18A and 18B are plan views for explaining deformation in the first link.

As shown in FIG. 4, the joint mechanism for the wrist of the robot R according to the first embodiment of the present invention includes a wrist rotating joint 10A at an intermediate location of the lower arm link 2 for pivoting the wrist and a drive mechanism 11A for generating the rotation movement of the lower arm link 2.

The lower arm link 2 includes, in addition to the base link (first member) 21, a second member 22, a third member 23, a fourth member 24, and a fifth member 25.

As shown in FIG. 17, the base link 21 includes a disk member 21b. The disk member 21b is provided at an end of the base link 21 on the side of the elbow and has a hole 21b₁ in an end face of the base link 21 on the side of the elbow.

The hole 21b₁ is a circle hole formed at a position shifted from a center of the disk member 21b and rotatably holds a protrusion (shaft) 102b of the second link 102 mentioned later.

The second member 22 has circle holes 22a and 22b. The hole (through hole) 22a rotatably supports the disk member 21b. The hole 22b rotatably holds the protrusion (shaft) 101b to allow a protrusion (shaft) 101b at one end of the first link 101A to relatively pivot.

As shown in FIG. 16, the third member 23 is connected to a fifth member 25. The fifth member 25 supports a drive mechanism 11A.

A fourth member 24 is an encoder (rotary encoder) for detecting a position (position change) of the first link 101A and held by the fifth member 25. As shown in FIG. 17, formed on an end on the side of the wrist of the fourth member 24 is a shaft 24a. The shaft 24a is inserted into a hole 103b of the third link 103. In the first embodiment of the present invention, the fourth member, i.e., the encoder 24 detects a rotary angle of the third link 103. The detected rotary angle is applied to the control circuit in the controller unit R5.

The second member 22 and the third member 23 are integrally fixed to the fifth member 25. Further, the fifth member 25 mutually fixes the drive mechanism 11A, the second member 22, and the fourth member 24.

As shown in FIG. 16, the wrist rotating joint 10A for rotating the wrist includes the first link 101A, the second link 102, and the third link 103.

The first link 101A is fixed to an output end 112a of a gear unit 112 of the drive mechanism 11A at an end thereof and fixed to the second link 102 at the other end thereof. As shown in FIG. 17, the first link 101A has a hole (socket) 101a in an end surface on the side of the elbow, the protrusion (shaft) 101b in an end surface on the side of the wrist at one end thereof, and a hole (through hole) 101c at the other end thereof. The hole 101a is provided for fixing the output end 112a of the harmonic drive gearing 112A. The protrusion 101b has a column shape and is inserted into the hole 22b to provide pivoting with respect to the hole 22b. The hole 101c is provided to allow a pin (not shown) to be inserted thereinto.

The first link 101A is a spring elastically deformable in a direction orthogonal with its axis, corresponding to the flexible member A21 shown in FIG. 1. Further as shown in FIG. 18, the first link 101A includes: a first arm 101d extending from the part in which the hole 101a is formed in a direction opposite to the hole 101c; an annular part (flexible part) connected to the first arm 101d; the part in which the hole 101a is formed; and a second arm 101f connecting the annular part 101e to the part in which the hole 101c is formed.

Further, a hole 101g is provided between the part in which the hole 101a is formed and the annular part 101e.

At an initial phase when the output is inputted from the harmonic drive gearing unit 112A, the first link 101A is deformed such that a shape of the hole 101g is dented (see FIG. 18A and FIG. 18B). The first link 101A has a low stiffness when the hole 101g is not dented, and a high stiffness when the shape of the hole 101g is dented. After that, the first link 101A shows overall deformation.

The first link 101A is formed preferably with SNCM (nickel-chrome molybdenum steel), SCM (chrome molybdenum steel), or the like.

The annular member 101e of the first link 101A has an extreme high spring constant in a direction between the holes 101a and 101c and thus shows almost no contraction and expansion in this direction. This is because a variation in a distance between the holes 101a and 101c changes parameters in the four-link mechanism, resulting in variation in speed increasing ratio.

As shown in FIG. 16, the second link 102 is connected to the first link 101A at one end, at the other end, the disk member 21b and the third link 103.

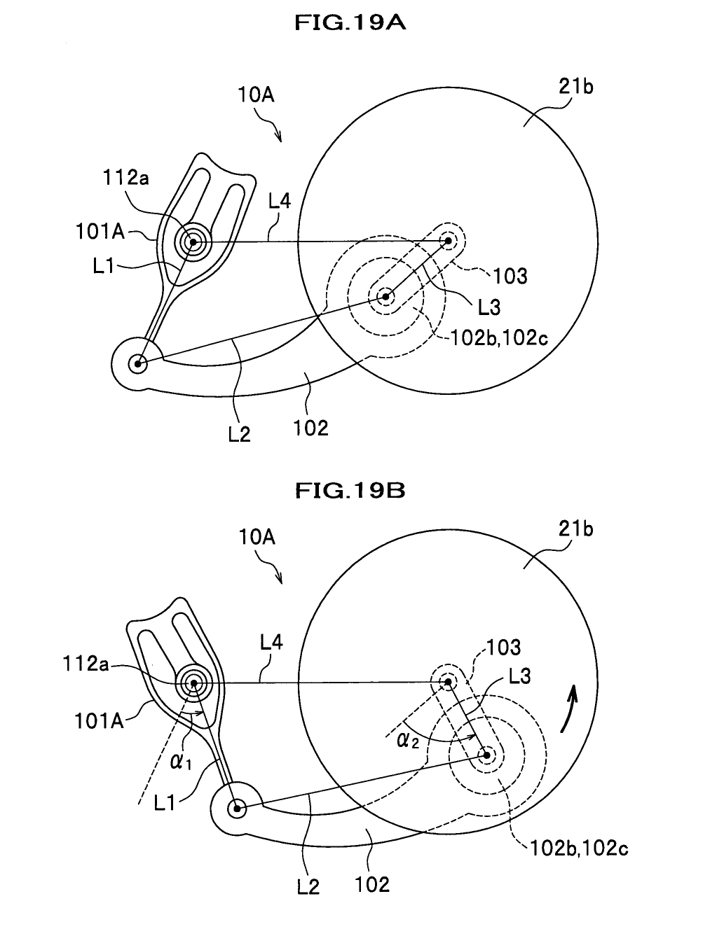

As shown in FIG. 17, the second link 102 at one end is divided into two parts in which holes 102a and 102a are formed and, at the other end, has a protrusion (shaft) 102b (see FIG. 19) on the side of the wrist and a hole (socket) 102c formed on the side of the elbow.

The holes 102a and 102a are provided to allow a pin (not shown) to insert thereinto. The pin is inserted into the holes 102a, 101c, and 102a to pivotally connect the first link 101A and the second link 102.

The protrusion 102b on the side of the wrist has a column shape which is inserted into the hole 21b₁ to pivot the first link 101A.

The hole 102c on the side of the elbow pivotally supports the protrusion 103a of the third link 103.

As shown in FIG. 16, the third link 103 is connected to the second link 102 at one end thereof and the fourth member 24 at the other end thereof.

As shown in FIG. 17, the third link 103 has a protrusion 103a at one end and the hole 103b at the other end.

The protrusion 103a is inserted into the hole (socket) 102c for pivotally connection to the second link 102.

The hole 103b is coaxial with the disk member 21b, and the third link 103 is fixed to the shaft 24a at the hole 103b. The shaft 24 is rotatable relative to a body of the encoder 24 to detect the rotary angle of the third link 103.

The drive mechanism 11A includes a motor 111A and the harmonic drive gearing 112A. The motor 111A corresponds to the motor A11 shown in FIG. 1 to generate a drive power for pivoting for the wrist joint.

The harmonic drive gearing 112A corresponds to the reducing mechanism A12 shown in FIG. 1 and reduces a rotation speed of the motor 111A.

The output end 112a of the harmonic drive gearing 112A is fixed to the hole 101a in the first link 101A.

The drive mechanism 11A includes an encoder ENC3. The encoder ENC3 detects a position change and a rotary position of the motor 111A. The detection result of the encoder ENC3 is applied to the control circuit in the control unit R5. The control circuit calculates a quantity of deformation of the first link 101A on the basis of the detection result of the encoders ENC3 and 24 to control driving the joint on the basis of the quantity of deformation of the first link 101A to suppress resonance in the first link 101A.

With reference to FIG. 19 will be described an operation of the wrist joint mechanism.

FIGS. 19A and 19B illustrate the operation of the wrist joint mechanism when viewed from X3 in FIG. 17. FIG. 19A shows a status before pivoting, and FIG. 19B shows a status after pivoting.

A body of the motor 111A and the fourth member (encoder) 24 are fixed to the fifth member 25. Thus, the wrist rotating joint 10A for pivoting the wrist can be regarded as the four-link mechanism including links L₁, L₂, L₃, and L₄ as shown in FIG. 19A. A part of the wrist rotating joint 10A (four link mechanism) except the link L₁ (first link 101A) corresponds to the speed-increasing converting device A22.

The link L₁ is correspondent to the first link 101A and defined as a line between the hole 101a (the output end 112a of the harmonic drive gearing 112A) of the first link 101A and the hole 101c (the hole 102a of the second link).

The link L₂ is correspondent to the second link 102 and defined as a line between the hole 102a of the second link and the protrusion 102b (the protrusion 103a of the third link 103, the hole 21b₁ of the disk member 21b).

The link L₃ is correspondent to the third link 103 and defined as a line between the protrusion 103a of the third link 103 (the protrusion 102b of the second link 102, the hole 21b₁ of the disk member 21b) and the hole 103b of the third link 103 (the shaft 24a of the fourth member 24, a center of the disk member 21b).

The link L₄ is defined as a line between the hole 103b of the third link 103 (the shaft 24a of the fourth member 24, the center of the disk member 21b) and the hole 101a of the first link 101A (the output end 112a of the harmonic drive gearing 112A).

When the link L₁ is pivoted by the output of the motor 111A transmitted through the harmonic drive gearing 112A in a status in which the link L₄ is fixed, the link L₃ is pivoted with respect to the link L₄, rotating the disk member 21b, i.e., the base link 21 (corresponds to the load member A3 in FIG. 1) about its rotation axis. Because the link L₃ is shorter than the link L₁, the first link 101A is elastically deformed as well as an output rotation angle α1 of the output end 112a of the harmonic drive gearing 112A is increased to a rotation angle α2. In other words, a rotation speed of the output of the harmonic drive gearing 112A is increased (see FIG. 19B).

This robot joint mechanism can be miniaturized and lightened because one of the links (first link 101A) in the four-link mechanism is elastically deformed, which can integrate the speed-increasing converting mechanism with the flexible member.

According to the robot joint mechanism, in the annular member (flexible member) 101e, a compression force and a tensile force are symmetrically generated, providing the spring constants which are identical with each other clockwise and counterclockwise in the first link (spring member) 101A.

### Second Embodiment

### The Wrist Joint Mechanism Is Modified

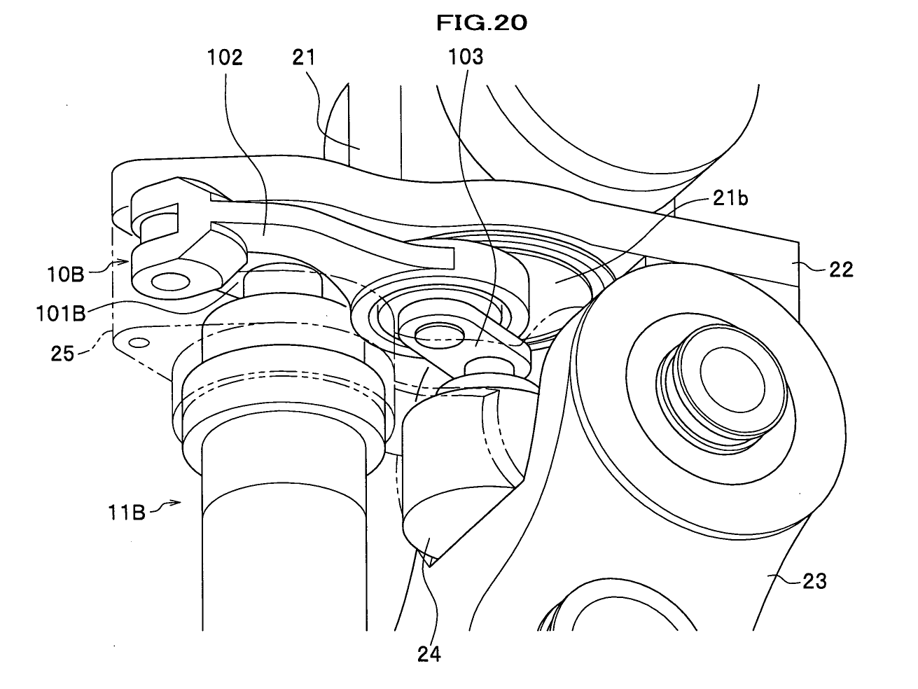

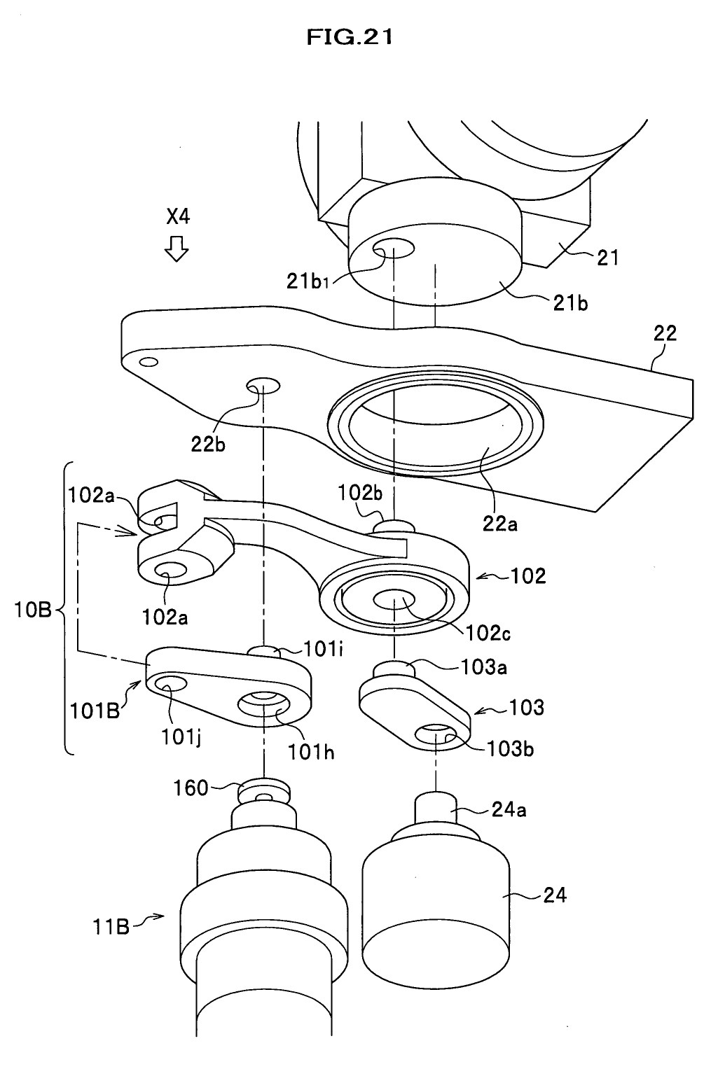

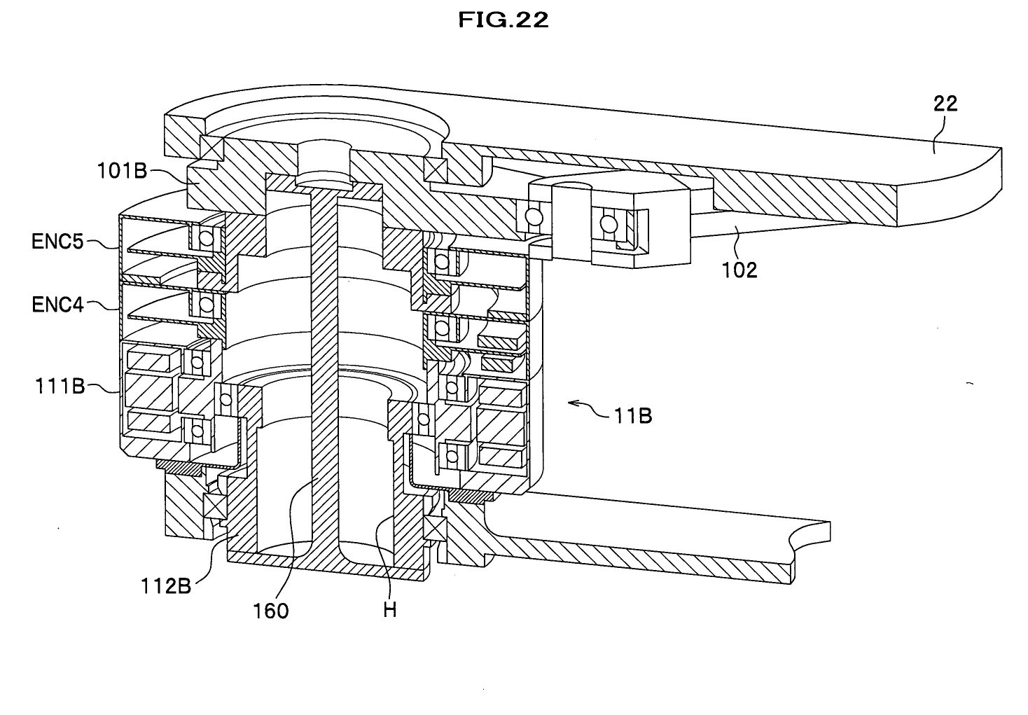

Will be described a second embodiment in which the wrist joint mechanism is modified about different points. FIG. 20 is a perspective view of the wrist joint mechanism according to the second embodiment of the present invention. FIG. 21 is an exploded perspective view of main parts shown in FIG. 20. FIG. 22 is a sectional view of a drive mechanism shown in FIG. 20.

As shown in FIG. 20, the wrist joint mechanism of the robot R according to the second embodiment includes a joint member 10B at an intermediate location of the lower arm link 2 for rotating the wrist and a drive mechanism 11B for driving the joint member 103.

As shown in FIG. 21, the joint member 10B for rotating the wrist includes a first link 101B in place of the first link 101A in the first embodiment.

The first link 101B is connected to a torsion bar 160 at one end thereof and the second link 102 at the other end thereof. As shown in FIG. 21, the first link 101B is formed to have a hole (socket) 101h in an surface on the side of the elbow at one end thereof, a protrusion (shaft) 101i on a surface on the side of the wrist at the one end, and a hole (through hole) 101j in the other end. The hole 101h is provided for fixing the torsion bar 160. The protrusion 101i has a cylindrical shape and inserted into a hole 22b to be pivoted. Inserted into the hole 101j is a pin (not shown).

As shown in FIG. 22, the drive mechanism 11B includes a motor 111B, the harmonic drive gearing 112B, and the torsion bar 160.

The motor 111B generates a drive power for rotation in the wrist joint and corresponds to the motor A11 shown in FIG. 1.

The harmonic drive gearing 112B reduces a rotation speed of the motor 111A through force conversion.

The torsion bar 160 corresponds to the flexible member A21 shown in FIG. 1, one end thereof being fixed to the output end of the harmonic drive gearing 112B, the other end being fixed to the first link 101B.

The torsion bar 160 is formed preferably with SNCM (nickel-chrome molybdenum steel), SCM (chrome molybdenum steel) or the like.

The drive mechanism 11B includes encoders ENC4 and ENC5.

The encoder ENC4 detects a rotary position variation and a rotary position of the motor 111B. The encoder ENC5 detects a rotary position of the first link 101B.

Detection results of the encoders ENC4 and ENC5 are applied to the control circuit of the controller unit R5. The control circuit calculates a quantity of twist of the torsion bar 160 on the basis of the detection results of the encoder ENC4 and ENC5 to control driving the joint on the basis of the calculated quantity of twist to suppress resonance of the torsion bar 160.

The drive mechanism 11B includes the encoder ENC5, the encoder ENC4, the motor 111B, the harmonic drive gearing 112B arranged in this order. These components have a hollow structure (through hole H) into which the torsion bar 160 is disposed. This arrangement provides a high space efficiency with a sufficient length of the torsion bar 160.

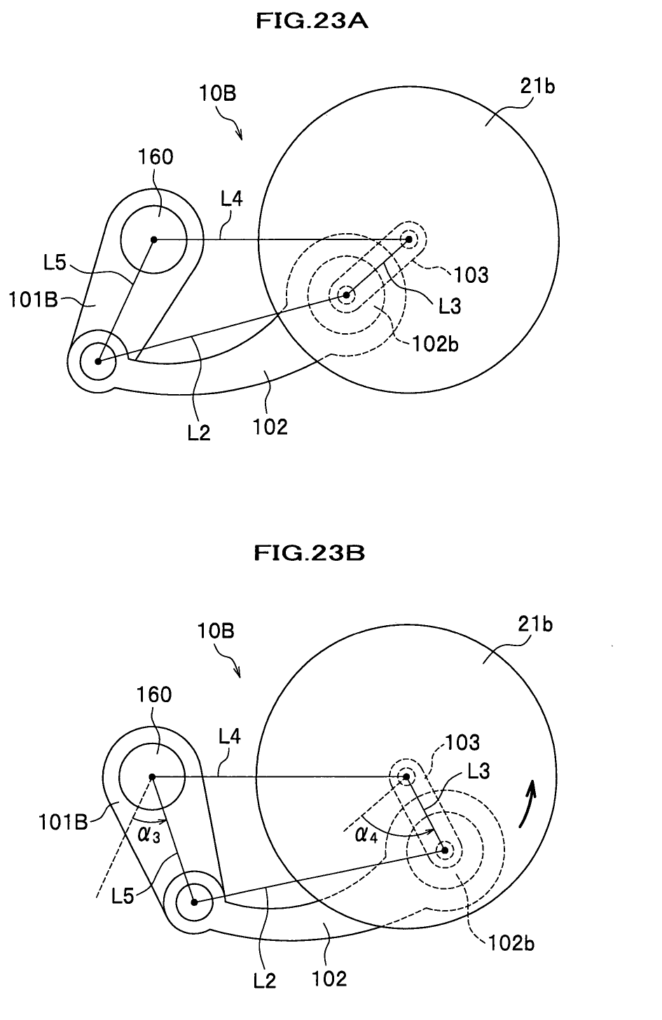

With reference FIGS. 23A and 23B, will be described an operation of the joint mechanism for pivoting the wrist.

FIGS. 23A and 23B illustrate the operation of the joint mechanism. FIG. 23A shows a status before pivoting, and FIG. 23B shows a status after pivoting. FIGS. 23A and 23B show illustrations viewed from X4 in FIG. 21.

A body of the motor 111B and the fourth member 24 are fixed to the fifth member 25. Thus, the joint member 10B for rotating the wrist can be regarded as a four-link mechanism including links L₅, L₂, L₃, and L₄ as shown in FIG. 23A. The joint member 10B for rotating the wrist (four-link mechanism) corresponds to the speed-increasing converting mechanism A2 shown in FIG. 1.

The link L₅ is correspondent to the first link 101B and defined as a line between the hole 101h (the torsion bar 160) of the first link 101B and the hole 101j (the hole 102a of the second link) of the first link 101B.

The link L₂ is correspondent to the second link 102 and defined as a line between the hole 102a of the second link and the protrusion 102b of the second link 102 (the protrusion 103a of the third link, the hole 21b₁ of the disk member 21b).

The link L₃ is correspondent to the third link 103 and defined as a line between the protrusion 103a (the protrusion 102b of the second link 102, the hole 21b₁ of the disk member 21b) and the hole 103b (the shaft 24a of the fourth member 24, a center of the disk member 21b) of the third link 103.

The link L₄ is defined as a line between the hole 103b of the third link 103 (the shaft 24a of the fourth member, the center of the disk member 21b) and the hole 101h of the first link 101B (the torsion bar 160).

When the link L₅ is pivoted by an output of the motor 111B transmitted through the harmonic drive gearing 112B in a status in which the link L4 is fixed, the link L₃ is pivoted relative to the link L₄, rotating the disk member 21b, namely, the base link 21 (corresponding to the load member A3 shown in FIG. 1) about its axis. Because the link L₃ is shorter than the link L₅, an output rotation angle α3 of the output end 112a of the harmonic drive gearing 112A is increased to a rotation angle α4. In other words, a speed (for example, an angular velocity, and a rotation speed) of the output of the harmonic drive gearing 112A is increased (see FIG. 23B).

The present invention is not limited to the above-described embodiments, but can be modified.

For example, in the first and second embodiments, the vertical axis as a first pivoting axis and the lateral axis as a second pivoting axis are disposed orthogonally. However, as long as the first pivoting axis (vertical axis) and the second pivoting axis (lateral axis) intersect each other on a plan view, the vertical swing operation and the lateral swing operation can be made by adaptively adjusting movement distances of the first rod 71 and the second rod 72. Further, combination of the vertical swing movement with the lateral movement of the hand 8 provides a slantwise movement and a circular movement of the hand 8 relative to the vertical axis 4a and the lateral axis 4b. In the first and second embodiments, the four-link mechanism 1 is used for the vertical swing movement. However, the present invention is not limited to this, but the four-link mechanism 1 may be used for the lateral swing movement.

In the first and second embodiments, the first rod 71 and the second rod 72 are connected to the main link 5 at locations which are shifted from the lateral axis 4b and in parallel to the lateral axis 4b on one and the other sides of the vertical axis 4a, respectively. The present invention is not limited to this, but the first rod 71 and the second rod 72 may be connected to the main link 5 at locations which are shifted from the vertical axis 4a and in parallel to the vertical axis 4a on one and the other sides of the lateral axis 4b, respectively.

More specifically, in the first and second embodiments, the first rod 71 and the second rod 72 are connected, as shown in FIG. 4, to the main link bodies 51a and 51b on both sides of the vertical axis 4a. However, the first rod 71 and the second rod 72 may be connected to one of the main links 51a and 51b at the connecting members 52 and 53 on both sides of the lateral axis 4b, respectively. Further, with change in arrangement of the first rod 71 and the second rod 72, the first motor 91 and the second motor 92 and the like in the drive mechanism 9 may be changed. In this structure, the forward or backward movements of the first rod 71 and the second rod 72 by the same distance pivot the main link 5 in the lateral direction (see FIG. 7). Further, one of the first and the second rods 71 and 72 is moved forward or backward and the other is moved backward or forward, pivoting the main link 5 in the vertical swing direction (see FIG. 5).

In the first and second embodiments, the first and second rods 71 and 72 are connected to the main link 5 with the universal joints 71a and 72b having two variances and the output arms 95 and 96 with ball and socket joints 95a and 96a having three variances. However, the present invention is not limited to this, inversely, the connection parts on the side of the main link 5 may use ball and socket joints, and connection parts on the side of the output arms 95 and 96 may use universal joints. The reason why the ball socket joints are used at one of the connection parts of the first and second rods 71 and 72 is that the first and second rods 71 and 72 receive twisting forces during pivoting movements.

Thus, if the universal joints are used for the connection parts of both ends of the first and second rods 71 and 72, i.e., one ends on the side of the main link 5 and the other ends on the output arms 95 and 96, another members are necessary for releasing twisting forces. On the other hand, if the ball and socket joints are used for the connection parts of both ends of the first and second rods 71 and 72, i.e., one ends on the side of the main link 5 and the other ends on the output arms 95 and 96, another members are necessary for restricting the first and second rods 71 and 72 to prevent unintentional rotation.

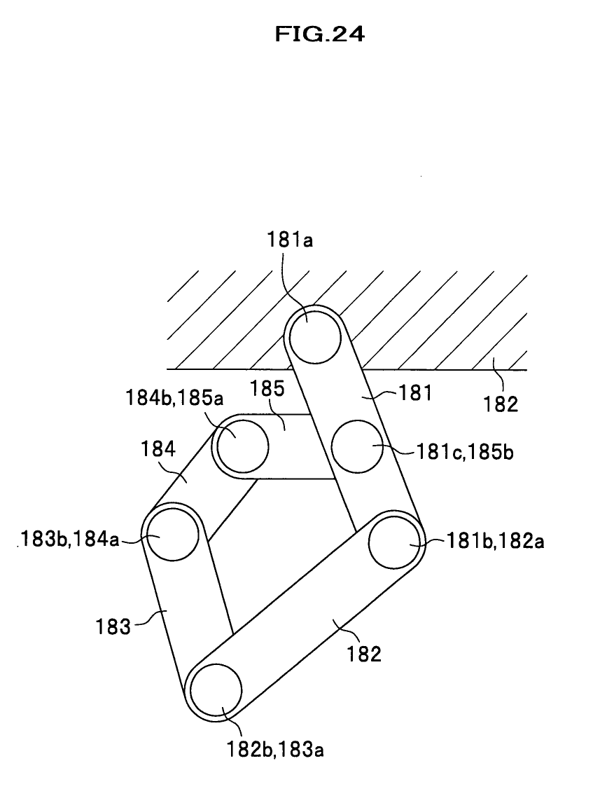

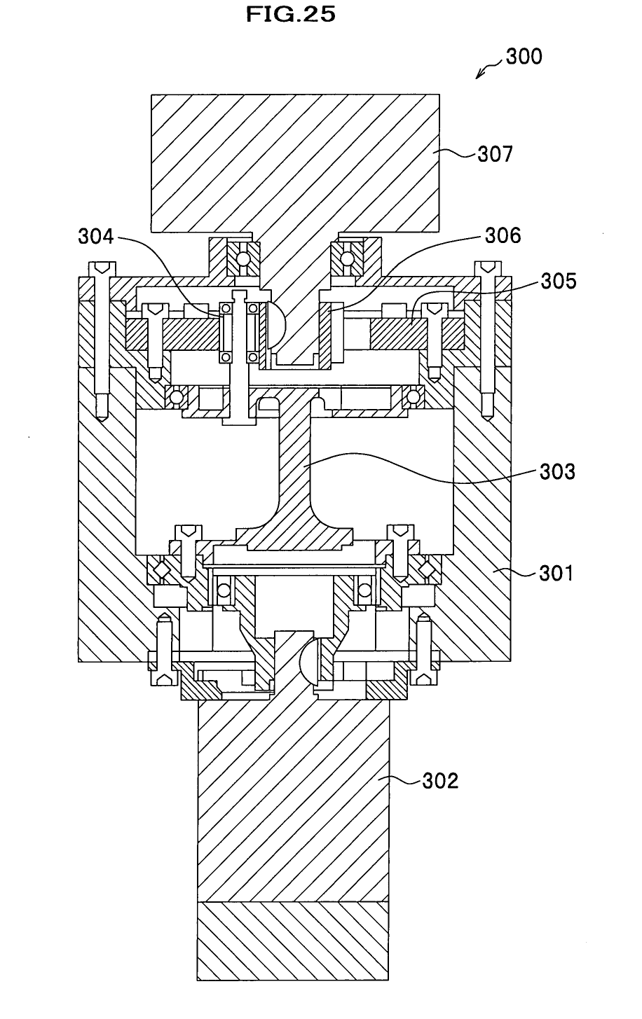

As the speed-increasing converting mechanism, a five-link mechanism and planet gear mechanisms are usable. FIG. 24 illustrates a modification of the speed-increasing converting mechanism, i.e., a five-link mechanism, according to the present invention.

As shown in FIG. 24, the speed-increasing converting mechanism as the five-link mechanism includes links 181, 182, 183, 184, and 185.

The link 181 is connected at one end thereof to a fixing member 182 of the robot R and pivotally connected at the other end to one end 182a of the link 182. The link 182 is pivotally connected at one end thereof to the other end 181b of the link 181, and the other end 182b is pivotally connected to one end 183a of the link 183. The link 183 is pivotally connected at one end 183a to the other end 182b of the link 182. The other end 183b is pivotally connected one end 184a of the link 184. The link 184 is pivotally connected at one end thereof to the other end 183b of the link 183a, and the other end 184b is pivotally connected to one end 185a of the link 185. The link 185 is connected at one end thereof to the other end 184b of the link 184. The other end 185b is pivotally connected to an intermediate part 181c of the link 181.

A flexible member is fixed to the link 183, and the load member is fixed to the link 184. In other words, the joint axis between the link 183 and the link 184 serves as an input axis and an output axis. In other words, this can be defined as a coaxial speed-increasing converting mechanism.

FIG. 25 illustrates a modification of the speed-increasing converting mechanism including a planet gear mechanism.

The planet gear mechanism 300 includes a case 301, an input member 302, a torsion bar 303, a planet gear 304, a sun gear 306, and an internal gear 305.

The case 301 rotatably supports the input member 302 and houses the torsion bar 303, the planet gear 304, the internal gear 304, and the sun gear 306. The input member 302 is connected at one end thereof to a drive power source (not shown) and the torsion bar 303 at the other end thereof. The torsion bar 303 is connected at one end to the input member 302 and the planet gear 304 at the other end.

The planet gear 304 is engaged with the inner gear 305 and the sun gear 306. The inner gear 305 is fixed to the case 301 and engaged with the planet gear 304. The sun gear 306 is formed integrally with the load member 307 and engaged with the planet gear 304. A torque inputted to the input member 302 from the drive power source is transmitted to the load member 307 through the torsion bar 303, the planet gear 304 and the sun gear 306 with an increased speed.

Further, the torsion bar 303 transmits the torque with elastic deformation therein. Further, the element for detecting an elastic deformation of the flexible member is not limited to the encoder, but the elastic deformation may be detected by a strain gage installed in the elastic member. The robot joint mechanisms mentioned above are applicable to respective joints of the robot R.

If the robot joint mechanisms according to the present invention are applied to the arm joint 235R(L) and the wrist joint 236R(L), and 237R(L), this moderates transmission of vibrations, due to an impact applied to the gripping member (hand) 271R and 271L, to the trunk of the robot R.

Further, if the joint mechanism according to the present invention is applied to the shoulder joint 233R (L), this structure modulates transmission of vibrations, due to an impact applied to one of the joints (for example, an impact due to collision between the elbow of the robot R and a circumferential object), to the trunk of the robot R. Further, this structure moderates transmission of vibrations, generated by mechanisms in the upper body R2 or an impact applied to the upper body R2, to the gripping member (hands) 271R and 271L.

Further, if the robot R in which the joint mechanism according to the present invention is applied to the Y neck joint 241, this structure modulates transmission of vibrations accompanied with swings by walking or running of the robot R, to the head 4, improving an accuracy in recognizing system using cameras installed in the head R4.

Further, if the joint mechanism according to the present invention is applied to the ankle joints 215R (L) and 216R (L), this structure modulates transmission of vibrations, caused by an impact applied to one of the leg 217R (L), to the trunk of the robot R. The joint mechanism according to the present invention is applicable to other joints in the robot R.

The robot joint mechanism according to the present invention may include a detector for detecting change at a position of the output of the drive power source before speed increasing and a control circuit for controlling the drive power source on the basis of the detection result of the detector.

The detector may detect the change in position of the output of the drive power source provided between the flexible member and the speed-increasing converting mechanism.

In this case, influence of backlash and friction between the flexible member and the speed-increasing converting mechanism on the detection result can be suppressed.

Further, the robot joint mechanism according to the present invention may include a detector installed at a position after speed increase for detecting change in position of the output of the drive power source and a control circuit for controlling the drive power source on the basis of the detection result of the detector.

The detector may detect the change of the output of the drive power source at any location allowing the detection. In this case, the change in position of the output of the drive power source is detected after speed increase, improving an accuracy in detection.

According to the present invention, a robot joint mechanism “A” includes: the drive power source A1 for generating a mechanical drive power at an output member thereof with a first speed: a speed-increasing converting mechanism A2 for converting the drive power into an output power at an output member thereof with a second speed higher than the first speed; and a load A3 connected to the speed-increasing converting mechanism A2, wherein the speed-increasing converting mechanism A2 includes first and second parts, and the first part 153A comprises a flexible member for transmitting the drive power to the second part 151A, or 152A through deformation of the flexible member, the flexible member having a spring constant lower than a spring constant of the second part 151A, or 152A.

The invention claimed is:

1. A robot joint mechanism including a drive power source and a load member driven by an output of the drive power source, comprising:
speeding-up means coupled to the drive power source and the load member such that the output of the drive power source is transmitted to the load member with the output of the drive power source speeded up, and wherein the speeding-up means transmits the output of the drive power source with a part of the speeding-up means elastically deformed.

2. The robot joint mechanism as claimed in claim 1, wherein the drive power source comprises:
a motor; and
a reducing mechanism for reducing a speed of an output of the motor and transmitting a reduced output of the motor to the speeding-up means.

3. The robot joint mechanism as claimed in claim 1, wherein the speeding-up means comprises:
an elastic member coupled to the drive power source; and
a speeding-up mechanism couple to the elastic member and the load member, wherein the output of the drive power source transmitted through the elastic member is transmitted to the load member with speeding up.

4. The robot joint mechanism as claimed in claim 3, wherein the elastic member comprises an annular spring elastically deformable in a twisting direction, and wherein the annular spring comprises
a center part coupled to one of the drive power source and the load member;
a peripheral member, coupled to the other of the drive power source and the load member, arranged around the center part in a radial direction of the center part; and
a flexible member for connecting the center part to the peripheral part.

5. The robot joint mechanism as claimed in claim 4, wherein the flexible part is line-symmetry about at least one axis on a cross section orthogonal to a rotation axis of the annular spring.

6. The robot joint mechanism as claimed in claim 4, wherein the flexible part is n-rotationally symmetrical about the rotation axis of the annular spring, n being a natural number more than one.

7. The robot joint mechanism as claimed in claim 5, wherein the flexible part is n-rotationally symmetrical about the rotation axis of the annular spring, n being a natural number more than one.

8. The robot joint mechanism as claimed in claim 1, wherein the speeding-up means comprises a four-link mechanism, and in the four-link mechanism, one link for transmitting the output of the drive power source is elastically deformable in a displacement direction of the link.

9. The robot joint mechanism as claimed in claim 7, wherein in the four link mechanism, the one link for transmitting the output of the drive power source comprises a spring member elastically deformable in the displacement direction of the one link, and wherein the flexible member of the spring member is symmetrical about a plane including two connection axes of the one link.

10. A method of driving a robot joint mechanism for driving a load member by an output of a drive power source, comprising the steps of:
reducing a speed of an output of the motor;
transmitting the output of the drive power source through an elastic member; and
speeding up the output of the drive power source transmitted through the elastic member and transmitting the speeded-up output of the drive power source to the load member.
